(19) United States
(12) Patent Application Publication
(10) Pub. No.: US 2026/0016741 A1
(43) Pub. Date: Jan. 15, 2026

(54) DISPLAY SYSTEM, SPATIAL FILTER AND METHOD

(71) Applicant: VividQ Limited, London (GB)

(72) Inventors: Christian FIELDHOUSE, London (GB); Alfred James NEWMAN, London (GB); Indi PRITCHARD, London (GB)

(21) Appl. No.: 19/336,243

(22) Filed: Sep. 22, 2025

Related U.S. Application Data
(63) Continuation of application No. PCT/GB2024/050782, filed on Mar. 22, 2024.

(30) Foreign Application Priority Data
Mar. 23, 2023 (GB) 2304249.2
Aug. 2, 2023 (GB) 2311881.3

(51) Int. Cl. G03B 21/14

(52) U.S. Cl. CPC G03B 21/145

(57) ABSTRACT

A display system comprises: an illumination system configured to emit at least partially coherent light; a spatial light modulator, SLM, illuminated by the illumination system and for applying a modulation pattern to illuminating light, the SLM configured to form a single modulation pattern, H, simultaneously representing a plurality of image fields, information relating to each image field of the plurality of image fields occupying a different portion of the Fourier Transform of H, F(H); an optical system arranged to receive the light modulated by the SLM and to produce a Fourier plane of the SLM; and a spatial filter positioned substantially in the Fourier plane of the SLM, the spatial filter comprising a plurality of regions, each region corresponding to a portion of F(H) representing an image field, and each region configured to pass light relating to the image field corresponding to that region. In some examples, in the single modulation pattern, information relating to an image field having greatest perceptual significance to a viewer occupies a largest portion of F(H).

### CROSS-REFERENCE TO RELATED APPLICATIONS

This application is a continuation under 35 U.S.C. § 120 International Application No. PCT/GB2024/050782, filed Mar. 22, 2024 which claims priority to United Kingdom Application No. GB2304249.2, filed Mar. 23, 2023, and United Kingdom Application No. GB2311881.3, filed Aug. 2, 2023 under 35 U.S.C. § 119(a). Each of the above-referenced patent applications is incorporated by reference in its entirety.

### TECHNICAL FIELD

The present invention relates to a display system, a spatial filter that may be used in the display system and a method of operating the display system. In particular, the present invention relates to a display system capable of displaying multiple image fields using a single modulation pattern of a modulator.

### BACKGROUND

Display systems have a refresh rate, typically expressed in frames per second or Hz, indicating how many frames can be displayed per unit of time. A higher refresh rate allows motion to be perceived more smoothly, for example.

As well as smoother motion, higher refresh rates may enable other operation modes. For example, in a holographic display system, a higher refresh rate may allow techniques such as noise averaging and eyebox expansion.

It would be desirable for a display system to be capable of displaying an increased number of image fields in each unit of time.

### SUMMARY

The present disclosure makes use of the observation that a single modulation pattern on a modulator can encode multiple image fields targeted at, or occupying, different parts of the spatial-frequency domain, such as the Fourier domain. Throughout this document, the “Fourier domain” refers to a spatial frequency domain of the pattern displayed on the modulator. “Image fields” may also be called image information or graphical information. An image field may be one of, but is not limited to, a 2D image, a 3D image, a hologram, an individual view of a 3D scene, a plurality or continuum of views of a 3D scene, a colour channel, an image with a noise profile, an image with additional constraining data, or a component of any of the above. As long as those image fields do not interfere coherently, or have a partial coherence, they all can be perceived by a viewer by a combination in the human eye without a significant effect on perceived image quality. A spatial filter targeted at the region corresponding to the image field in the spatial-frequency domain can prevent coherent interference. In this way two or more image fields can be displayed simultaneously on a modulator using a single modulation pattern, allowing an increase in the number of image fields that can be displayed per unit time.

According to a first aspect of the invention, there is provided a display system comprising: an illumination system configured to emit at least partially coherent light; a spatial light modulator, SLM, illuminated by the illumination system and for applying a modulation pattern to illuminating light, the SLM configured to form a single modulation pattern, H, simultaneously representing a plurality of image fields, information relating to each image field of the plurality of image fields occupying a different portion of the Fourier Transform of H, F(H); an optical system arranged to receive the light modulated by the SLM and to produce a Fourier plane of the SLM; and a spatial filter positioned substantially in the Fourier plane of the SLM, the spatial filter comprising a plurality of regions, each region corresponding to a portion of F(H) representing an image field, and each region configured to pass light relating to the image field corresponding to that region. In the single modulation pattern, information relating to an image field having greatest perceptual significance to a viewer occupies a largest portion of F(H).

In general, the Fourier transform of H, F(H) is divided or decomposed into multiple portions, with each portion representing information from a single image field and each portion is substantially prevented from perceptible interference to a viewer with others of the portions by the spatial filter. The independent image fields which each portion corresponds to can then be added incoherently at the eye. Furthermore, by allocating a larger portion of F(H) to the image field which has the greatest perceptual significance to the viewer, properties of the human eye can be used to improve perceived image quality.

It will be appreciated that the information relating to each image field in F(H) need not correspond exactly to a Fourier transform of the image field, for example because of possible cropping and/or the addition of focus terms.

Individual regions of the spatial filter may overlap. For example, due to wavelength-dependent diffraction effects, regions may overlap each other at the spatial filter. A colour of the spatial filter may be different where regions overlap, for example, when a red region overlaps a green region, the overlap may appear yellow. The reference to light relating to an image field corresponding to the region of the spatial filter includes any such overlap, for example a red region may include a part of the spatial filter that appears red and a part of the spatial filter that appears yellow where the red region is overlapped with the green region.

Reference to the spatial filter being configured to “pass light” is used in the filter sense in terms of the light which can continue to downstream optical elements. Light may be “passed” by transmission or reflection.

Each image field may be a colour channel of an image. Here, and throughout this disclosure, reference to “colour” includes perceptual colours and not only colours that can be represented by a single wavelength of light. Perceptual colours are those which can be perceived by a viewer due to a combination of wavelengths. Thus, a colour channel may be a colour such as magenta, which consists of red and blue wavelength light. Similarly, a colour channel may be white, which is a viewer's perception of light with wavelengths spread across the visible spectrum. It is understood that a range of spectral distributions of light sources can be perceived as white—there is no single, unique specification of “white light”.

The plurality of image fields may comprise at least three image fields. At least three image fields may allow display of colour images for example, and allow the most perceptually significant colour field (which may be white as noted above in some examples) to occupy the largest portion of F(H) for greater perceived image quality.

In one example, the plurality of image fields comprises a red image field, a green image field and a blue image field; and information relating to the green image field occupies the largest portion of F(H). By allocating the largest portion of F(H) to a green image field, the colour in which the human eye has the most sensitivity receives proportionally more information than the red and blue image fields.

Similarly, in another example the plurality of image fields comprises a substantially white light field; and the white or substantially white light field occupies the largest portion of F(H). When a substantially white field is included in the display system, the human eye has the greatest sensitivity to the overall luminance provided by the substantially white field. Again this receives proportionally more information than the other fields. The reference here to “substantially” white allows colours which are generally perceived as white.

When there is a white image field, the plurality of image fields may further comprise a red image field, a green image field and a blue image field. Full colour can still be provided through the red, green and blue image fields. In that case, information relating to the red image field, information relating to the green image field and information relating to the blue image field occupy a same size portion of F(H). Each field may be relatively small compared to the white field as the majority of the luminance information is provided by the white field. Alternatively, the green image field may occupy a larger portion of F(H) than the red and blue image fields.

It can be advantageous for the plurality of image fields to include a yellow image field and/or a cyan image field. The human eye is sensitive to variations in chromaticity and so may detect variation in yellow and/or cyan when formed from combinations of red, green and blue. Providing a yellow and/or cyan source may provide a more uniform perceived chromaticity of those colours, increasing image quality. Further sources and image fields may also be provided corresponding to other colours, such as magenta, orange and so on.

In these and other examples, white light may have a range of wavelengths between 450 and 750 nm. Red may have a wavelength between 610 nm-750 nm such as 617 nm or 635 nm. Blue light may have a wavelength around 400 nm-495 nm, for example, 450 nm. Green light may have a wavelength in the range of 495 nm-570 nm or in the range of 520 nm-560 nm, such as around 520 nm. Yellow light may have a wavelength in the range of 565-590 nm, such as around 580 nm. Cyan light may have a wavelength in the range of 485-505 nm, such as about 505 nm.

The illumination system may be provided in any suitable way. In some examples, the illumination system comprises a plurality of light sources, such as from separate discrete light sources having the required wavelength. A plurality of light sources may also be provided by a suitable optical system from a single light source, such as by forming a plurality of images of a light source. In other examples, an illumination system may comprise a single light source, such as a white light source which may provide white light and also red, green, blue and/or other colour light. Where white light, or other broader wavelength range light, is used to provide a narrower band source, it can be filtered before or after the SLM in an optical path. For example, filtering of a white light source to particular colour channels may be combined with the spatial filter. Other combinations are possible.

As discussed in WO2023/227902, incorporated herein by reference for all purposes, the level of coherence of an illumination system can limit the perceived depths it gives in a holographic display. A holographic display may therefore provide a dedicated green source to impart a greater range of depth information, and derive a red and blue source from a white source with reduced range of depth information. Other combinations are possible.

According to a second aspect of the present invention, there is provided a display system comprising:
an illumination system configured to emit at least partially coherent light;
a spatial light modulator, SLM, illuminated by the illumination system and for applying a modulation pattern to illuminating light;
an optical system arranged to receive the light modulated by the SLM and to produce a Fourier plane of the SLM; and
a spatial filter positioned substantially in the Fourier plane of the SLM;
wherein:
the SLM is configured to form a single modulation pattern, H, simultaneously representing at least a first image field occupying a first portion of the Fourier Transform of H, F(H), and a second image field occupying a second, different portion of F(H), and
the spatial filter is configured such that light corresponding to the first portion of F(H) does not interfere coherently, or interferes partially coherently, with light corresponding to the second portion of F(H).

In general, the Fourier transform of H, F(H) is divided or decomposed into multiple portions, with each portion containing information from a single image field and each portion is prevented from coherent interference with others by the spatial filter. The independent image field which each portion corresponds to can then be added incoherently at the eye. In some examples, partial coherent interference between portions of different or overlapping wavelengths can be acceptable, such as at a point of overlap in the spatial filter. There may also be partial coherent interference between a white region and other colour regions of the spatial filter. These have been found not have a significant effect on perceived image quality.

Such a display system allows for the display of multiple image fields using a single modulation pattern of the SLM because the spatial filter ensures the image fields do not interfere coherently with each other. A viewer's eye will receive the multiple image fields but may perceptually combine them into a single image. For example, the multiple image fields may be different renderings of a same scene having different noise patterns, and the viewer's eye may combine them to average and reduce the perception of noise. In another example, the multiple image fields may be separate colour fields of the same scene, and the viewer's eye may combine them to perceive a colour image. In a further example, the multiple image fields may be of the same scene but expand the field in which a viewer's eye can perceive the image (sometimes referred to as “eyebox expansion”).

The second portion may occupy a larger area of F(H) than the first portion. For example, an area of the second portion of F(H) is larger than an area of the first portion of F(H). This can allow a larger effective resolution to be given to one colour than another, for example a colour which is more perceptually important, such as green in an RGB representation of an image or white in an RGBW representation of an image, may be given a higher effective resolution by occupying a larger area of F(H). Diffraction and wavelength-scaling effects may mean that the corresponding region in the Fourier plane of the SLM is not necessarily larger, a lower wavelength (such as red) will occupy a relatively larger region at the Fourier plane than it does in the mathematical Fourier space.

It will be appreciated that lack of coherent interference may be achieved in several ways including physically blocking all passage of light outside the desired region of the Fourier plane, by blocking or allowing particular frequencies of light, and in a time-sequential fashion by selectively activating regions of the spatial filter between blocking and allowing light to pass. Put another way, the spatial filter may be configured so the display of the multiple image fields is simultaneous and/or involves time-sequential display over a duration that the SLM is forming the single modulation pattern.

Advantageously, it has been found that this technique provides at least a two-fold increase in the number of image fields that can be displayed per unit time compared to a display system that relies on displaying a single image field per modulation pattern of an SLM. This may be advantageous when the display system comprises architecture having a relatively slow refresh rate, such as Liquid Crystal on Silicon (LCoS). A further advantage is that it can be easier to increase the resolution of an SLM than to increase its refresh rate. Although simultaneously representing multiple image fields in a single modulation pattern reduces the effective resolution of the SLM for each of the image fields, it is relatively easier to increase the resolution to compensate than it is to increase the frame rate.

The display system may offer further advantages for colour holographic display because simultaneous display of colour channels enables accurate registration of colour channels with respect to one another. Furthermore, holographic display systems typically use “colour-sequential” display where colour fields are displayed sequentially in time so that, for example three modulation patterns of the SLM are required for a colour image. Such systems are more compact and cost effective than including an SLM for each colour, however colour-sequential display is known to suffer from “colour-breakup” where changes in position of a viewer's eye between the time of individual colour fields results in the viewer perceiving separate images. The present display system can reduce the effect of colour breakup.

The illumination system may comprise one or more light sources. A light source may be, for example, a laser or other coherent or at least partially coherent light source including light emitting diodes (LEDs). The one or more light sources may comprise a single emitter or multiple emitters and may emit light having a single wavelength or multiple wavelengths (and hence act as multiple sources). A light source may be a physical emitter or an image of an emitter. Some examples may include an optical system configured so that one or more “master” sources provides multiple sources, wherein each of the multiple sources is an image of a “master” source. In some examples, this is achieved with a microlens array. The illumination system may behave as one or more point-like sources. The sources may be somewhat extended, but by nature of being at least partially (spatially) coherent, they are somewhat localised. A source point may be physical point-like emitter (such as an LED or laser diode), an image of a point like emitter, or another form of at least partially coherent illumination, such as a laser cavity. The source points may be before the SLM (i.e. diverging illumination), at infinity (i.e. collimated illumination), or virtual points after the SLM (i.e. converging illumination).

The illumination system may include white light source, such as a white LED. This may provide a white light source directly and may also be filtered to provide colour light sources, this filtering may be before the SLM, such as within the illumination system, or after the SLM, such as at the spatial filter. In other words, light sources of different wavelengths (colours) may be provided by a single physical emitter (e.g. a white LED), but where different portions of its spectra (e.g. a red band, a green band and a blue band) can be treated as separate incoherent sources. This single physical emitter then behaves equivalently to having first and second mutually incoherent sources, having a first and a second spectrum, but where the first and second emission areas are coincident.

The SLM can be any modulator or modulation means suitable for modulating an amplitude and/or phase of coherent, semi-coherent or at least partially coherent light. This includes LCOS devices, Digital Micromirror Devices (DMD) and Liquid Crystals. In some examples, the SLM is an amplitude-modulating LCoS.

The optical system may comprise a lens. The lens is preferably a Fourier lens and may be formed from multiple elements. In some examples the lens may be a lens array, where the lenses comprising the array extend over an imaging area. The optical system may form a plane containing an image of the source(s) after being modulated by the SLM. We refer to this plane as the Fourier plane of the SLM. The modulated amplitude in this plane is related to the Fourier Transform of a modulation pattern, F(H), but the scale and position of the modulated amplitude additionally depends on factors including the wavelength of the light and angle of illumination.

The SLM, optical system and spatial filter may be aligned along an optical path. For example, they may be substantially coaxial in some examples. Other arrangements are also possible, for example a folded optical path with mirror and/or prism elements in the optical path, possibly to allow a more compact arrangement.

The spatial filter can have any suitable construction, such using transmissive or reflective principles. A transmissive spatial filter may delimit a set of apertures through which light can pass and which generally block or otherwise prevent light from passing outside the apertures (for example the spatial filter may be configured to absorb light outside the apertures, or to reflect it elsewhere, outside of an optical path). A reflective spatial filter may comprise a region which reflects light towards an optical path to allow light to pass or reflect light away from the optical path to block the passage of light.

The illumination system may comprise a first light source and a second light source; wherein: the first light source and second light source are mutually incoherent; light passing through a first region defined by the spatial filter, and corresponding to the first portion of F(H), originates from the first light source; and light passing through a second region defined by the spatial filter, and corresponding to the second portion of F(H), originates from the second light source. The display system may therefore be capable of displaying multiple images simultaneously using light of the same, or different, wavelengths.

Each image field may correspond to a respective colour channel of a multicolour image, meaning that each of the multiple image fields are associated with the same scene. The first light source may have a first wavelength and the second light source may have a second wavelength which is different from the first wavelength. The first image field is for display at the first wavelength and the second image field is for display at the second wavelength. The first region defined by the spatial filter comprises a spectral filter allowing the first wavelength to pass. The second region defined by the spatial filter comprises a spectral filter allowing the second wavelength to pass. That is, the multiple image fields at respective wavelengths can be separated in the Fourier plane through the use of spectral filters. In this way coloured images can be displayed. The SLM displays multiple image fields simultaneously that are simultaneously filtered by the spatial filter. Problems such as colour-breakup and colour registration are significantly reduced or eliminated.

The number of image fields can be expanded to any number of component colour image fields, such as three, four or more. It is common to represent colour images for display by the combination of three component image fields. The single modulation pattern may therefore further simultaneously represent a third image field occupying third portion of F(H) different from the first portion and the second portion. The spatial filter may then be further configured to filter light corresponding to at least the third portion. In some examples, the illumination system comprises a third light source having the third wavelength, and the spatial filter defines a third region corresponding to the third portion of F(H), the third region comprising a spectral filter allowing the third wavelength to pass. In some examples, the first, second and third wavelengths correspond to Red, Green and Blue light respectively (also referred to as RGB). Red may have a wavelength between 610 nm-750 nm such as 617 nm or 635 nm. Blue light may have a wavelength around 400 nm-495 nm, for example, 450 nm. Green light may have a wavelength in the range of 495 nm-570 nm or in the range of 520 nm-560 nm, such as around 520 nm. While an RGB example is given, other component colours can also be used. Such a three-colour display system improves the number of image fields per unit time three-fold over a colour-sequential display.

Another example may use four image fields, and each image field may correspond to a distinct colour. In that case, the single modulation pattern further simultaneously represents a fourth image field occupying a fourth portion of F(H) different from the first portion, the second portion and the third portion; the spatial filter is further configured to filter light corresponding to at least the fourth portion; and each of the first, second, third and fourth image fields corresponds to a distinct colour. “Distinct” is used to mean that each of the first, second, third and fourth image fields corresponds to a colour which is different from the others. In some examples, one of the first image field, the second image field, the third image field and the fourth image field corresponds to a white image field. In other examples, the distinct colours may be red, green, blue and yellow, or other distinct chromaticities.

The second portion may occupy a larger area of F(H) then the third portion. The area of the second portion of F(H) may be larger than an area of the third portion of F(H). Thus, the second portion may have a larger area than both the first portion and the third portion.

In examples, the first portion corresponds to a red image field, the second portion corresponds to a green image field and the third portion corresponds to a blue image field. For example, the first wavelength corresponds to red light, the second wavelength corresponds to green light and the third wavelength corresponds to blue light. In that case the first portion may occupy a larger area of F(H) than of the third portion. An area of the second portion may be larger than areas of both the first and third portions. Unlike colour-sequential display, a display where multiple colour image fields are displayed simultaneously does not have to display an equal area (in the Fourier plane) for each colour as happens with colour-sequential display. In this case, the spatial filter allows more green light to be transmitted than red and blue light. This provides a greater share of the available “information bandwidth” to green light, which is perceptually more important than red and blue light. Likewise, the second portion may correspond to white light, such as in an RGBW representation, with allowing a greater share of the “information bandwidth” to the white light which is the most perceptually important. In some examples, the area of the second portion is approximately twice the sum of the area of the first and third portions. In an RGB example, this prioritises the transmission of green light over that of red and blue light. Other configurations are possible. In some examples, the area of the second portion is larger than twice the sum of the area of the first and third portions. In examples which do not use red, green and blue light, a larger area may be devoted to the colour which is most perceptually important.

The area of the first portion of F(H) may be larger than the area of the third portion of F(H). That is, in an RGB example, the spatial filter may allow more of the Fourier transform area to be used for red light than blue light. This prioritises red light, which is more perceptually important than blue light, and so may improve the image quality of the display system. In examples which do not use red, green and blue light, larger areas may be devoted to colours which are most perceptually important.

Regions of the spatial filter correspond to the portions of F(H). In the spatial filter, the size of the region may be affected by wavelength scaling and/or diffraction effects. The area of the second region, which corresponds to the second portion, may be larger than the area of both the first region and the third region, corresponding to the first and third portions. That is, the area of the second region may be larger than the first region and the third region even after wavelength scaling and/or diffraction effects are taken into account.

In some examples, the second region may correspond to a green image field and the first region may correspond to a red image field, whereupon the second region would not be larger than the first region due to wavelength and/or diffraction effects alone. In other words, in such examples the green region being larger in area than the red region of the spatial filter implies that it corresponds to a larger portion of F(H) than the first portion of F(H). In some examples, the second portion may correspond to a white image field.

A first region corresponding to the first portion of F(H) and a second region corresponding to the second portion of F(H) may overlap. Due to wavelength scaling and possibly also different positioning of the first and second light sources in the illumination system the physical position of the first and second regions at the spatial filter may overlap. This is not detrimental to image quality if there are no coherent interference effects between the first and second light source where the first and second region overlap, such as is the case when they are mutually incoherent by having different wavelengths. Such an overlap can also be beneficial. First, the overlap reduces the area of the Fourier plane corresponding to the different portions of F(H). This can allow other techniques such as time sequential eyebox expansion. Second, alignment of the individual colours with the viewer's pupil may also be easier to achieve and maintain. In one example, the illumination system comprises a first light source and a second light source arranged so that at the spatial filter the first region is substantially contained within the second region.

When the first and second light sources are configured to emit light having different first and second wavelengths, the spatial filter may comprise respective spectral filters, as discussed above. In the region of the overlap, a spectral filter may allow transmission of portion(s) of the visible spectrum comprising both the first and second wavelength. When the first, second and third regions substantially overlap in the Fourier plane, the spatial filter may delimit an aperture in the overlap permitting transmission of all colours. In other words, a spectral filter may not be needed where all three colours overlap in the Fourier plane.

The spatial filter may define a region having a shape with a largest dimension that is aligned with a direction of consecutive horizontal and/or vertical diffraction orders in the Fourier plane. A “largest dimension” is used to refer to the longest continuous straight line that can be contained within the shape. For example, squares and rectangles have their diagonals as their largest dimension. Many SLMs feature an array of approximately square pixels. Illumination of the SLM results in a diffraction pattern comprising a central, zero-order, diffraction peak as well as regularly spaced higher order diffraction peaks that together form a grid of diffraction peaks in the Fourier plane. By aligning the largest dimension of the aperture with the direction of consecutive horizontal and/or vertical diffraction orders, higher horizontal and/or vertical spatial frequencies can be transmitted by the spatial filter. In other words the horizontal and/or vertical spatial frequencies may be filtered less. This is useful when the image field comprises high horizontal and/or vertical spatial frequencies as is the case when the image field includes text.

The region may be a square, rotated 45 degrees, so that the diagonals of the square align with the directions of consecutive horizontal and/or vertical diffraction orders in the Fourier plane. The region may have a shape of an “I” or “H”, rotated such that the largest dimensions are aligned with a direction of consecutive horizontal and/or vertical diffraction orders in the Fourier plane. In that case, the “I” or “H” shape is for the most perceptually important colour, such as green. The less perceptually important colours, such as the red and blue image fields, are small squares rotated 45 degrees and cut out from a larger square to form the “I” or “H” shape for the most perceptually important shape.

In examples where the spatial filter delimits three apertures, first, second and third apertures may form shapes all having respective largest dimensions that are aligned with the direction of consecutive horizontal and/or vertical diffraction orders in the Fourier plane.

Some examples may use a spatial filter which selectively allows light corresponding to a first portion and a second portion to pass at different times. This is useful when the same light source is used for each portion. In this case coherent interference is prevented by activating a single region, or a set of regions with mutually incoherent light sources, of the spatial filter at any one time. It can be easier to manufacture such a shutter for high switching speeds than it is an SLM. By time-sequentially switching the first and second shutters between states, the first and second portions of F(H) can be transmitted within the duration that the single modulation pattern is formed by the SLM.

The spatial filter may comprise a spectral filter. A spectral filter may have regions corresponding to the image fields with a passband corresponding to the wavelength(s) of each image field. Some examples may combine the spectral filter with shutters so that a shutter and/or a spectral filter may define a region of the spatial filter which selectively allows light to pass.

In a third aspect, a display system comprises: an illumination system configured to emit at least partially coherent light; a spatial light modulator, SLM, illuminated by the illumination system and for applying a modulation pattern to illuminating light; an optical system arranged to receive the light modulated by the SLM and to produce a Fourier plane of the SLM; and a spatial filter positioned substantially in the Fourier plane of the SLM. The SLM is configured to form a single modulation pattern, H, simultaneously representing at least a first image field occupying a first portion of the Fourier Transform of H, F(H), and a second image field occupying a second, different portion of F(H). The spatial filter comprises first and second shutters that can be switched between a state that allows light to pass and a state that blocks light, the first shutter corresponding to the first portion of F(H) and the second shutter corresponding to the second portion of F(H), wherein in use: a single one of the first and second shutters is in the state that allows light to pass at any given time, and both the first and second shutters are configured to be in the state that allows light to pass for respective periods within a duration that the SLM is forming the single modulation pattern. Light associated with the first portion of F(H) cannot coherently interfere with light associated with the second portion of F(H) because the light associated with the second portion of F(H) is blocked by the spatial filter and vice versa.

The single modulation pattern, H, may be a first modulation pattern generated at a first time, and the SLM may then be configured to form a second single modulation pattern, H′, at a second time different from the first time. The second single modulation pattern simultaneously represents a first further image field and a second further image field, each occupying different portions of the Fourier Transform of H′. F(H′). The spatial filter is configured such that, at the first time, at least the first portion of F(H) is allowed to pass, and the spatial filter is further configured such that, at the second time, at least a first portion of F(H′) corresponding to the further first image field is allowed to pass. In allowing portions of F(H) and F(H′) to pass, the spatial filter may block at least one portion of F(H) that is not required, such as the zero order diffraction peak, and higher diffraction orders. Other examples may additionally or alternatively block conjugate terms, such as when the SLM is an amplitude SLM. The spatial filter may also be further configured such that at the first time, F(H′) is blocked by the spatial filter, and, at the second time, F(H) is blocked by the spatial filter.

Time-sequentially displaying images at respective different regions of the Fourier plane increases the effective size of the eyebox. The relatively high rate of displaying the light fields at different positions in quick succession results in the viewer perceiving one larger image due to persistence of vision. The spatial filter may comprise one or more blocking elements or controllable shutters configured to selectively allow light to pass and block light of the respective portions of F(H) and F(H′) at any given time.

In some examples, the illumination system is a first illumination system, and the display system further comprises a second illumination system configured to emit at least partially coherent light, which is spatially offset from the first illumination system. The single modulation pattern, H, may be a first modulation pattern generated at a first time, and the SLM may be configured to form a second single modulation pattern, H′, at a second time different from the first time, the second single modulation pattern simultaneously representing a first further image field and a second further image field, each occupying different portions of the Fourier Transform of H′, F(H′). The spatial filter may be configured so that: at the first time, at least a portion of light from the first illumination system is allowed to pass, and at the second time, at least a portion of light from the second illumination system is allowed to pass. In allowing portions of F(H) and F(H′) to pass, the spatial filter may block at least one portion of F(H) that is not required, such as the zero order diffraction peak, and higher diffraction orders. Other examples may additionally or alternatively block conjugate terms, such as when the SLM is an amplitude SLM. The spatial filter may also be further configured such that, at the first time, light from the second illumination system is not allowed to pass, and, at the second time, light from the first illumination system is not allowed to pass.

The spatial filter may comprise first and second shutters that can be switched between a state that allows light to pass and a state that does not allow light to pass. At the first time, the first shutter may be in the state that allows at least a portion of light from the first illumination system to pass and the second shutter may be in the state that does not allow light from the second illumination system to pass, and at the second time, the second shutter may be in the state that allows at least a portion of light from the second illumination system to pass and the first shutter may be in the state that does not allow light from the first illumination system to pass.

The first and second illumination systems can each comprise one or more light sources (e.g. RGB light sources) and the spatial offsetting of the first and second illumination systems causes images to be formed at different positions in a plane of a viewer's pupil. This can allow the position of an image in this plane to be varied by varying the illumination system which is used.

In some examples, the display system may further comprise: a pupil tracking system configured to determine a location of a viewer's pupil; and a processing system configured to determine which of the first and second illumination systems corresponds to the determined location of the viewer's pupil; and control the first and second illumination systems based on the determined pupil location. This allows for pupil tracking in a simple manner with fewer (perhaps no) moving components. The pupil tracking system is used to determine the location of the pupil so that appropriate illumination system(s) are activated to produce an image at that location. As the viewer's pupil moves, different illumination systems can then be activated. In some examples, the processing system may be a dedicated processing system associated with or part of the pupil tracking system. In other examples, the processing system may be a general processing system of the display system.

The display system may comprise one or more master sources, wherein: the first illumination system comprises first images of the one or more master sources, and the second illumination system comprises second images of the one or more master sources. In some examples, the display system further comprises a lens array, wherein: the light sources of the first illumination system are images of the one or more master sources formed by a first lens of the lens array, and the light sources of the second illumination system are images of the master sources formed by a second lens of the lens array.

The display system may comprise a further spatial filter positioned after the lens array for controlling which of the first and second illumination systems illuminates the SLM.

According to a fourth aspect of the present invention, there is provided a spatial filter for positioning in a Fourier plane of a spatial light modulator in a display system, the spatial filter defining: a first region allowing a first subset of the visible electromagnetic spectrum to pass; and a second region allowing a second subset of the visible electromagnetic spectrum to pass; wherein: the first subset of the visible electromagnetic spectrum is different from the second subset of the visible electromagnetic spectrum and the first and second regions at least partially overlap.

The spatial filter according to the fourth aspect may be used in the display system according to the first, second or third aspect. The spatial filter allows for the simultaneous display of two image fields at different wavelengths for a single modulation pattern formed by the SLM.

The spatial filter may define a third region allowing transmission of a third subset of the visible electromagnetic spectrum to pass that is different from the first and second subsets of the visible electromagnetic spectrum; wherein: the first subset of the visible electromagnetic spectrum includes red light, the second subset of the visible electromagnetic spectrum includes green light and the third subset of the visible electromagnetic spectrum includes blue light, and an area of the second region is larger than areas of both the first and third regions.

That is, the spatial filter may allow more green light to be transmitted than red and blue light. This provides a greater share of the available “information bandwidth” to green light, which is perceptually more important than red and blue light. In some examples, the area of the second portion is approximately twice the sum of the area of the first portion and the area of the third portion. This prioritises the transmission of green light over that of red and blue light.

The area of the first region may be larger than the area of the third region. That is, the spatial filter may allow more red light to be transmitted than blue light. This prioritises the transmission of red light, which is more perceptually important than blue light, and so may improve the image quality of the display system, while also having the increased effective frame rate as discussed above.

It will be appreciated that the spatial filter may also have any of the features discussed above for the first, second or third aspect. The spatial filter may form part of a display system.

Display systems discussed above have many potential applications, including head-mounted displays and heads-up displays. The increase in effective frame rate also makes them useful for holographic displays allowing techniques such as time-sequential noise averaging and eyebox expansion.

According to a fifth aspect of the present invention, there is provided a method comprising determining a first modulation pattern, H₁, corresponding to a first image field, wherein the Fourier transform of H₁, F(H₁) occupies a first portion of the Fourier domain; determining a second modulation pattern, H₂, corresponding to a second image field, wherein the Fourier transform of H₂, F(H₂) occupies a second portion of the Fourier domain which is different from the first portion; displaying H₁ and H₂ simultaneously via a single modulation pattern on an SLM; illuminating the SLM with at least partially coherent light to produce a modulated output; and filtering the modulated output using a spatial filter substantially positioned in a Fourier plane of the SLM and configured such that light corresponding to F(H₁) does not interfere coherently, or interferes partially coherently, with light corresponding to F(H₂). The second portion may be larger than the first portion.

The method provides the above-mentioned advantages of allowing more image fields to be displayed within the duration that the SLM is forming a single modulation pattern. The method may be particularly advantageous when used with an SLM architecture having a relatively slow refresh rate, such as LCOS. The additional image fields (per unit time) may be used with techniques such as different colour image fields, noise averaging and eyebox expansion.

The first image field may correspond to a first subset of the visible electromagnetic spectrum. The second image field may correspond to a second subset of the visible electromagnetic spectrum. The first subset of the visible electromagnetic spectrum is then different from the second subset of the visible electromagnetic spectrum. That is, the method may use light of different wavelengths to generate a single polychromatic image perceived by a viewer. The different wavelengths may also be overlapping, such as overlapping but different ranges of wavelengths. Put another way the different wavelengths may or may not be mutually exclusive.

The spatial filter may comprise a first region corresponding to the first portion of F(H) and a second region corresponding to the second portion of F(H) and the first and second region at least partially overlap. In that case, the light allowed to pass by the first region may originate from a first at least partially-coherent light source and light allowed to pass by the second region may originate from a second at least partially-coherent light source, the first and second at least partially-coherent light sources may be mutually incoherent, and the first and second at least partially-coherent light sources are arranged such that the first and second regions at least partially overlap in the Fourier plane.

H₁ and H₂ may be displayed at a first time and a first illumination system comprising the at least partially coherent light source illuminates the SLM at the first time, the method further comprising: determining a third modulation pattern, H₃, corresponding to a third image field; determining a fourth modulation pattern, H₄, corresponding to a fourth image field; and

displaying, at a second time different from the first time, H₃ and H₄ simultaneously via a further single modulation pattern on the SLM, illuminating the SLM with a second illumination system comprising a second at least partially coherent light source, the second illumination system being spatially offset from the first illumination system. The spatial filter is further configured so that: at the first time, light corresponding to H₁ and H₂ is allowed to pass, and at the second time, light corresponding to H₃ and H₄ is allowed to pass. In allowing portions of H₁ and H₂ and H₃ and H₄ to pass, the spatial filter may block at least one portion of that is not required, such as the zero order diffraction peak and higher diffraction orders. Other examples may additionally or alternatively block conjugate terms, such as when the SLM is an amplitude SLM. The spatial filter may be further configured so that, at the first time, light corresponding to H₃ and H₄ is not allowed to pass, and, at the second time, light corresponding to H₁ and H₂ is not allowed to pass.

The method may further comprise: determining a location of a viewer's pupil; and controlling the first and second illumination systems based on the determined pupil location.

According to a sixth aspect of the present invention, there is provided a display system comprising first and second illumination systems, a spatial light modulator (SLM), an output optical system, a pupil-tracking system and a processing system. The first illumination system is configured to generate a first set of beams of at least partially coherent light. The second illumination system is configured to generate a second set of beams of at least partially coherent light and is spatially offset from the first illumination system. The SLM is arranged to be illuminated by the first and second sets of beams of light. Each of the first and second sets of beams of light are incident on the SLM at a different angle. The output optical system is arranged to receive light modulated by the SLM. The pupil tracking system is configured to determine a location of a viewer's pupil. The processing system is configured to: determine at least one active beam of the first and second sets of beams that corresponds to the determined location of the viewer's pupil; and control the first and second illumination systems so that the at least one active beam is used to illuminate the SLM.

The first and second sets of beams of at least partially coherent light may each comprise one or more beams of light.

Such a display system allows for pupil tracking without complex mechanical mechanisms. By generating multiple beams of light, the display system is capable of displaying images over a larger area. That is, by illuminating the SLM at different angles, the generated images are distributed over a region of a plane in which the viewer's pupil is located and which images are used can be chosen based on a position of a user's pupil.

Rather than cover the whole of the large area simultaneously, the pupil tracking system is used to determine the location of the pupil and activate an appropriate beam(s) to produce an image at that location. Based on the determined location of the pupil, particular individual, or subsets of, beams of light may be selected such that image(s) are generated at, or at least near to, the pupil.

The display system may also comprise a spatial filter as has been described with reference to at least the first to fourth aspects. The illumination system may be controllable so that at least one of the beams is emitted at any given time. The illumination systems are spatially separated so that they are incident on the SLM at different angles.

In some examples, the first and second illumination systems may each comprise respective sets of light sources, wherein the sets may include as few as one light source. Each light source from the first and second set of light sources may be configured to generate a single beam of at least partially coherent light. The first and second illumination systems may be respective portions of a light emitting diode (LED) array. Each generated image at the pupil will be relatively bright because the light originates from a corresponding source.

However, a plurality of sources/illumination systems may not be suitable, perhaps for reasons of cost and/or space. The display system may further comprise one or more master sources, wherein: the first set of light sources is one or more first images of the one or more master sources, and the second set of light sources is one or more second images of the one or more master sources. In some examples, the display system may comprise a lens array, wherein: the first images are formed by a first lens of the lens array, and the second images are formed by a second lens of the lens array. The display system may comprise a spatial filter positioned after the lens array for controlling which of the first and second illumination systems illuminates the SLM. This provides an alternative to using multiple sources and may overcome the difficulty in managing a large number of sources.

Shutters of the spatial filter may be switched between a state that allows light to pass and a state that does not allow light to pass. The shutters may be controllable by the processing system, and therefore may be switched based on the determined pupil location.

The processing system may be further configured to control the first and second illumination systems such that light from a single one of the first and second sets of beams of light is incident on the SLM at any given time.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a display system according to an example;

FIGS. 2, 3, 6, 8, 13, 14, 16 and 18 are example decompositions of the Fourier domain into portions for use with the display system of FIG. 1;

FIGS. 4, 5, 7, 9, 15, 17A and 19A are example physical spatial filters for positioning in the Fourier plane of the SLM in the display system of FIG. 1;

FIGS. 17B and 19B are diagrammatic representations of regions of the physical spatial filters in FIGS. 17A and 19A, respectively, which pass light corresponding to the portions in the Fourier Domain in FIGS. 16 and 18;

FIG. 10 shows another example display system;

FIG. 11 is an example physical spatial filter for positioning in the Fourier plane of the SLM in the display system of FIG. 10;

FIG. 12 is another example physical spatial filter for positioning in the Fourier plane of the SLM in a display system comprising six light sources;

FIG. 20 shows a method according to an example;

FIG. 21 shows an example virtual reality display system;

FIGS. 22 and 23 show further example display systems; and

FIG. 24 shows an example holographic optical engine.

### DETAILED DESCRIPTION

Displaying a larger number of image fields per unit time is desirable in many display systems. For example, more image fields per unit time may improve the smoothness of the appearance of moving images and/or allow the use of techniques such as noise averaging and eyebox expansion, which improve image quality.

Image quality is important in display systems and so some display systems include display devices that favour improved static image quality. Liquid Crystal on Silicon (LCoS) devices, for example, often have a relatively high contrast ratio, can reproduce deep blacks, and do not produce rainbow artifacts. However, LCoS devices typically suffer from relatively low refresh rates, particularly compared to other display architectures, such as digital micromirror devices (DMDs). Augmented Reality (AR) and Virtual Reality (VR) displays typically benefit from a higher refresh rate than static displays due to movements of the head of a user. The use of LCOS devices in AR and VR may therefore lead to unacceptable stuttering of the displayed images that result in disorientation and nausea.

The techniques described herein increase the number of images of fields that can be displayed per unit time in any SLM-based display system. The increased number of image fields can be used to, for example, deliver one or more of smoother video content, additional noise averaging and eyebox expansion. The techniques may also reduce problems such as colour breakup. The techniques described herein are not limited to use in AR and VR systems, and are also relevant for static displays such as HUD and projectors.

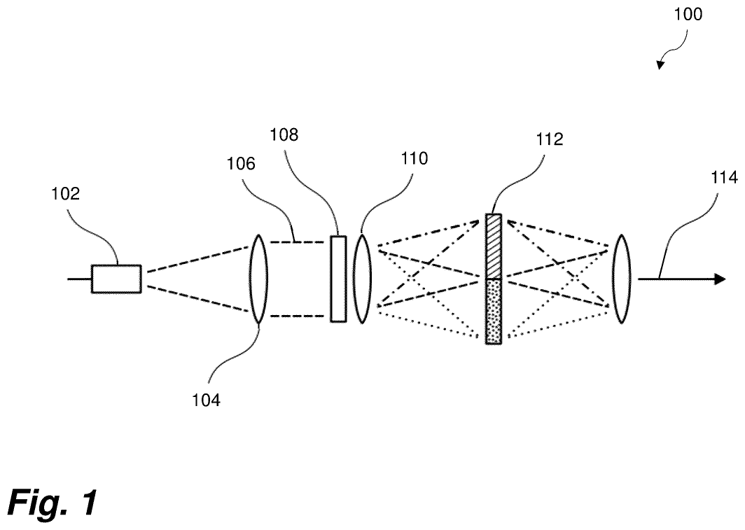

FIG. 1 shows, in general terms, a display system 100. The display system 100 comprises an illumination system 102 configured to emit at least partially coherent light. The illumination system 102 is configured to generate at least partially coherent light at one wavelength, or a plurality of wavelengths (corresponding to red, green and blue light, for example). The illumination system 102 may comprise one or more light sources. Each of the one or more light sources may be configured to generate respective at least partially coherent light at one or more wavelengths. The one or more light sources may, for example, comprise a laser module or an LED.

A condenser lens 104 is arranged to generate approximately collimated light 106 from the illumination system 102. By “approximately collimated” it is understood that the light need not be perfectly collimated and may be slightly diverging or slightly converging. An SLM 108 is arranged to be illuminated by the approximately collimated light 106. The SLM 108 is a device that manipulates the characteristics of incoming light in a spatially-varying manner to generate a modulation pattern, H. The SLM 108 may be configured to modulate at least one of the phase and amplitude of the light. The SLM 108 may be, for example, a Digital Micromirror Device (DMD), a liquid crystal display (LCD), and an LCOS, such as an amplitude LCoS or a phase LCOS. In FIG. 1, the SLM 108 is shown as transmissive for simplicity of illustration, but it is understood that it may be either transmissive or reflective.

An optical system 110 is configured to generate a Fourier transform of the modulation pattern generated by the SLM 108, F(H). In general, the optical system 110 may comprise any optical element(s) that generates the Fourier transform of an incoming light field. For example, the optical system may function as a Fourier lens and generate a Fourier transform of the light field at a predetermined plane in the optical path. The plane in which the Fourier transform of a light field is generated is referred to as the Fourier plane. Referring to FIG. 1, the Fourier plane can be thought of as the location of an image of a point source originating at the illumination source 102.

A spatial filter 112 is positioned at the Fourier plane of the optical system. More generally, the spatial filter 112 is positioned in, or close to, a Fourier plane of the SLM 108. The arrangement of the display system 100 is such that the Fourier transform of the modulation pattern from the SLM, F(H), is formed at a plane coinciding with the position of the spatial filter 112. This plane is the Fourier plane of the SLM 108 as imaged by the optical system 110.

The SLM 108 is configured to form a modulation pattern, H, from the approximately collimated light 106 received from the illumination source via the condenser lens 104. In the present disclosure, a single modulation pattern of the SLM generates two or more image fields simultaneously so that/(H) will comprise respective portions corresponding to the two or more image fields. As will be discussed in further detail below, each of the image fields may correspond to light received from a respective light source (comprised in the illumination system 102) or may be formed using a single light source.

The spatial filter 112 is arranged and/or configured to allow the passage of respective portions of F(H) that are associated with respective image fields, essentially de-multiplexing the multiple image fields so that they can be added incoherently at the viewer's eye. Multiple independent image fields can be viewed while the SLM 108 is forming a single modulation pattern. In this way, the display system is not restricted to the refresh rate of the SLM 108, and the number of image fields per unit time is defined by the combination of the refresh rate of the SLM 108 and the number of image fields that can be displayed simultaneously using a single modulation pattern of the SLM 108. Some specific examples are discussed later.

It will now be described in further detail how the multiple image fields can be simultaneously displayed by a single modulation pattern of an SLM and how the multiple image fields are de-multiplexed using a spatial filter positioned in the Fourier plane of the SLM.

### Simultaneous Image Generation

The Fourier transform of a target modulation pattern can be readily calculated, and so, therefore, can its extent in the Fourier plane. Algorithms, such as Gerchberg-Saxton, Fienup, Fidoc, Input-Output, Liu-Taghizadeh, and Hybrid Iterative Fourier Transform Algorithm (HIFTA), are known in which a modulation pattern can be calculated or determined which is targeted at a specific region of the Fourier plane.

A complication is that an SLM is only capable of generating a quantised representation of a desired target light field. For example, consider a hologram for display which is typically first calculated as a “full-complex” modulation pattern which comprises an array of values corresponding to each element (pixel) on the surface of a display device. Each value is a complex number with respective phase and amplitude. However, many display systems used for computer-generated holographic images, such as DMD and LCOS SLMs, have a finite range of values that they can reproduce.

The quantised modulation pattern, H₀, is displayed by quantising the initial full-complex hologram, calculated or determined with known techniques, for display. Holographic display systems typically include a lens that creates a Fourier transform of the modulation pattern displayed on the SLM, with the eye of a viewer causing an inverse Fourier transform to take place when viewed.

The present disclosure makes use of the observation that an optical system can be used to form the Fourier transform of H₀, F(H₀) at a position referred to as a Fourier plane of the SLM. This is the plane wherein the complex amplitude is described by a Fourier transform of the complex amplitude at the SLM, potentially modulo scaling or including a multiplicative spherical phase term.

The Fourier transform of a function of space (the target light field, H, is a function of space, H=H(x,y), for example) decomposes that function into its respective frequency components, kₓ and k_{y}.

The present disclosure uses the fact that an SLM can form a single modulation pattern that represents two or more image fields simultaneously, each targeted at different regions of the Fourier plane. A spatial filter is then used to prevent coherent interference of the targeted regions. Thus, F(H) will comprise portions that correspond to each of the two or more image fields that can be filtered so that the individual image fields reach the viewer's eye without interfering coherently.

As the display system is configured to prevent the portions interfering coherently, the modulation pattern for each image fields to be displayed simultaneously can simply be added. The effect of other image fields is filtered out in the Fourier domain, for example by using a spatial filter in a Fourier plane formed by an optical system.

The light associated with the multiple image fields must not interfere coherently, or must interfere only partially coherently, otherwise interference effects will render the multiple images indecipherable. Coherent interference may be avoided by varying the temporal and/or spatial coherence of the light sources within the illumination system. In some examples, each of the multiple image fields may be illuminated by light from a respective light source within the illumination system. Multiple light sources may be used if they are mutually incoherent, that is, where light from each of the light sources does not undergo coherent interference.

A spatial filter positioned in the Fourier plane and delimiting a specific configuration of regions or apertures can be used to prevent this coherent interference. An example spatial filter 112 is shown in side view in FIG. 1. The regions of the spatial filter have a physical extent corresponding to the region of the Fourier plane to which each of the multiple image fields have been targeted. The spatial filter restricts certain spatial frequencies from being transmitted. Each of the regions allow light corresponding to each portion of the Fourier domain to pass through the filter and thus reach a viewer's eye where the image fields are added incoherently.

A single modulation pattern determined in this way need not involve partitioning, or tiling, the surface of the SLM to form sub-modulation patterns corresponding to each image field. FIG. 1 illustrates that light corresponding to each image field may originate from across the surface of the SLM 108 because the filtering is in the Fourier plane. It is the relative positions of the portions corresponding to each image field in the Fourier domain that determines the modulation pattern formed by the SLM.

### Increasing Effective Frame Rate Through Spatial Filtering

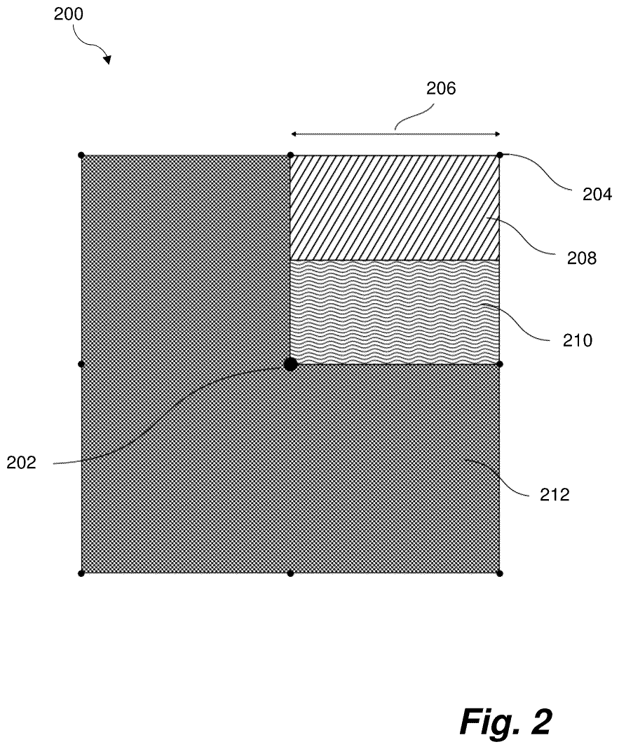

FIG. 2 shows an example decomposition 200 of part of the spatial frequency domain, with the horizontal direction representing the spatial frequency kₓ axis, and the vertical direction representing the spatial frequency k_{y} axis. The spatial frequency domain may also be referred to as the Fourier domain and frequency space. The central point 202 represents a zero-order diffraction peak. Higher-order diffraction peaks form a grid of unit cells in the Fourier domain. A distance 206 between consecutive horizontal (and vertical) diffraction peaks is referred to as the inter-order distance 206 and in physical space is equal to λf/p, where λ is the wavelength of the light illuminating the SLM, f is the focal length of the lens, and p is the pixel pitch of the display.

In this example, two portions of the Fourier space are targeted by respective image fields, a first portion 208 and a second portion 210. In this example, the lower left corner of the second portion 210 is aligned with the zero-order diffraction peak 202 and the upper right corner of the first portion 208 is aligned with the first horizonal and vertical diffraction peak 204. The first and second portions 208, 210 have equal areas, do not overlap, and together occupy the (square) space bounded by a unit cell in the Fourier domain. In this example, the first and second portions 208, 210 form contiguous rectangles, each having horizontal lengths equal to the inter-order distance 206 and heights equal to half the inter-order distance 206.

An SLM may be configured to form a single modulation pattern, H, corresponding to two image fields H₁ and H₂. The Fourier transforms of the two image fields, F(H₁) and F(H₂), are determined such that F(H₁) is targeted at the portion of the Fourier domain corresponding to the first portion 208, and F(H₂) is targeted at the portion of the Fourier domain corresponding to the second portion 210. F(H₁) and F(H₂) undergo an inverse Fourier transform at the viewer's eye to form H₁ and H₂ corresponding to the first and second image fields. Furthermore, H₁ and H₂ are incoherently added so that the viewer receives two image fields for a single modulation pattern of the SLM.

In this way, there is a two-fold increase in the number of image fields that the display system can display per unit time, at the expense of reducing the resolution by a half (because the amount of light transmitted corresponding to each image is halved). This allows some design freedom, allowing the designer to trade off resolution for a greater number of image fields per unit time, a possibility not previously available.

Properties of the first and second portions 208, 210 depend on the light source(s) that are used to illuminate the SLM. In a first example, two light sources are used to illuminate the SLM emitting light at different wavelengths (so that coherent interference between light from the two light sources is avoided). A physical spatial filter, positioned in the Fourier plane and corresponding to the decomposition 200 in the Fourier domain, may then comprise a first spectral filter region corresponding to the first portion 208 and arranged to allow a first subset of the visible electromagnetic spectrum that includes the wavelength of light emitted by the first light source to pass. Similarly, the physical spatial filer may comprise a second spectral filter region corresponding to the second portion 210 and arranged to allow a second subset of the visible electromagnetic spectrum that includes the wavelength of light emitted by the second light source to pass. In this first example, the multiple image fields generated by the single modulation pattern of the SLM may be transmitted simultaneously by the spatial filter, without the need for time-sequential switching of apertures.

The first and second image fields may correspond to respective colour channels of a colour image. The advantage here is that the two colour channels can be displayed simultaneously. Further examples below will discuss simultaneous display of three image fields corresponding to respective colour fields of an RGB colour image, but this could be extended to displaying multiple channels of any arbitrary colour space simultaneously.

A spectral filter allows a specific range (or ranges) of wavelengths to pass through. Spectral filters with defined nominal wavelength and full width at half maximum (FWHM, a measure of the passband) characteristics are commercially available, such as from Thorlabs. A spectral filter may also be produced using coloured inks. Additionally, a diffractive grating or holographic optical element (HOE) designed to diffract specific wavelengths or ranges of wavelengths may also act as a spectral filter.

In a second example, a single monochromatic light source may be used to illuminate the SLM. In this second example, to prevent coherent interference of light corresponding to the two image fields, it is necessary to limit the portions of light that are transmitted by a physical filter corresponding to the decomposition 200 at any one time. As in the first example, a first portion of F(H) 208 in the Fourier domain may correspond to light associated with a first image field that is targeted at a first region of the Fourier plane. Similarly, a second portion of F(H) 210 in the Fourier domain may correspond to light associated with a second image field that is targeted at a second region of the Fourier plane.

Such a physical spatial filter may comprise first and second shutters corresponding to the respective portions 208, 210. The first and second shutters may be controllable, such as by a controller (not shown), between a substantially transmissive state that allows light to pass and a substantially non-transmissive state that prevents light from passing. (Other examples may use other types of shutter, such as reflective rather than transmissive.) The first and second shutters may be configured such that only a single one of the first and second shutters allows light to pass at any given time. Furthermore, the first and second shutters may be configured to allow light to pass at some point within a duration that the single modulation pattern is formed by the SLM. The shutters may be configured to allow light corresponding to the first portion 208 of F(H) to be transmitted for a similar amount of time as light corresponding to the second portion 210 of F(H).

The controllable shutters can be manufactured in a variety of ways. For example, they could be manufactured of liquid crystal and operated to either substantially allow light to pass or substantially block light. The liquid crystal may have a high switching speed such as pi-cell or Ferroelectric LCD (FLCD). Other examples may use a DMD as the spatial filter, where the DMD is controlled to control what parts of the modulated light are allowed to pass through. Another example may use a rotating chopper wheel, with the chopper wheel rotating to define each of the plurality of apertures and the laser synchronised to the chopper wheel. The chopper wheel may use a stepper motor or similar to control rotational position, for example. Of course, the controllable shutters could utilise any suitable shutter technology, examples of which include Molecular-based, Quantum Optical and Plasmonic Metamaterials shutters.

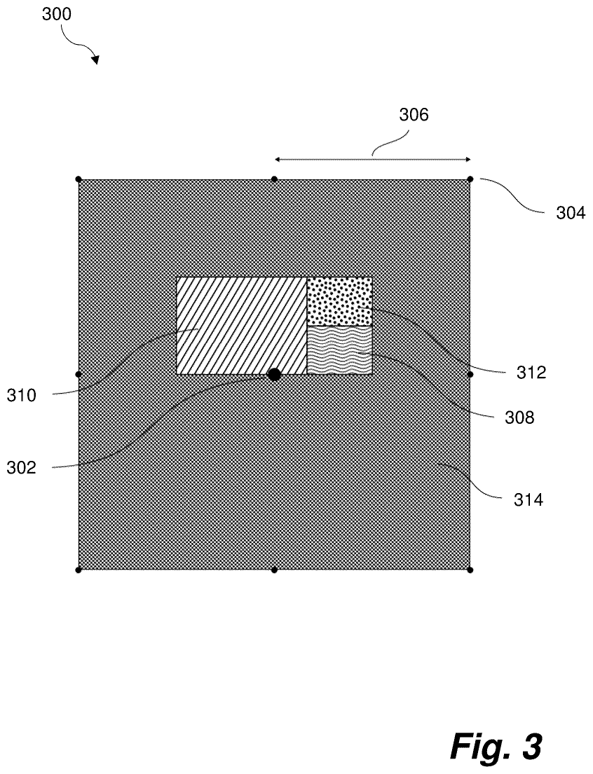

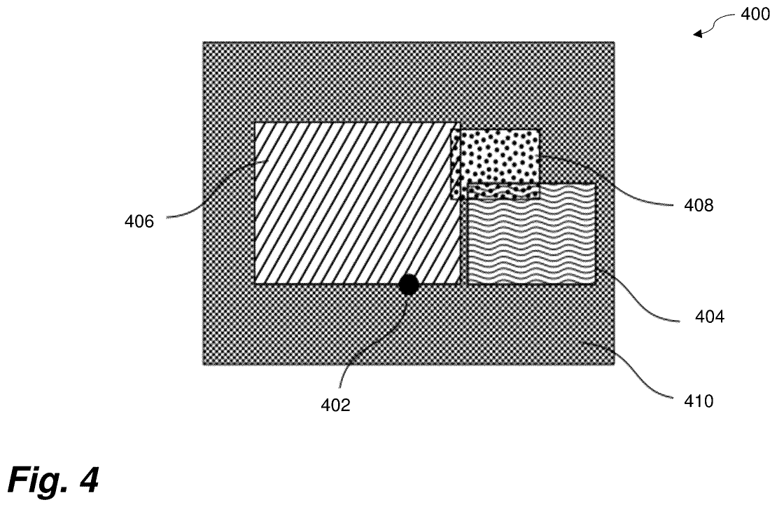

FIG. 3 shows another example decomposition 300 of part of the spatial frequency domain that may be used with the display system 100 illustrated in FIG. 1. FIG. 3 illustrates the position of the zero-order diffraction peak 302, the first order horizontal and vertical diffraction peak 304 and the inter-order distance 306, which are defined similarly as described above with for FIG. 2. As in FIG. 2, FIG. 3 depicts the decomposition 300 in the spatial frequency domain, with the horizontal direction representing the spatial frequency kₓ axis, and the vertical direction representing the spatial frequency k_{y} axis.

The decomposition 300 defines a first portion of F(H) 308, a second portion of F(H) 310 and a third portion of F(H) 312. In FIG. 3, the decomposition 300 for use with light having first, second and third wavelengths, and which may be generated by respective first, second and third light sources. As described above, each of the multiple image fields displayed by the modulation pattern of the SLM may correspond to light of a certain wavelength so that light at the first wavelength forms the first image field that corresponds to a first portion of F(H) 308 in the Fourier domain, light at the second wavelength forms the second image field that corresponds to a second portion of F(H) 310 in the Fourier domain, and light at the third wavelength forms the third image field and corresponds to a third portion of F(H) 312 in the Fourier domain.

In this example, the decomposition 300 is for use with an amplitude modulating SLM. As an amplitude modulating device, F(H) must not overlap with the Fourier transform of the complex conjugate of H, F(H*), to reduce noise effects. The union of portions 308, 310, 312 therefore occupies an area equal to half a unit cell in the Fourier domain.

In operation, the first portion of F(H) 308 is targeted at a first region of a spatial filter positioned substantially in the Fourier plane of the SLM, the second portion of F(H) 310 is targeted at a second region of the spatial filter and the third portion of F(H) 312 is targeted at a third region of the spatial filter. 12. The portion 314 of the decomposition 300 corresponds to a blocking region of a spatial filter which prevents light from passing. The spatial filter comprises a first spectral filter corresponding to the first portion of F(H) and allowing transmission of the first wavelength, a second spectral filter corresponding to the second portion of F(H) and allowing transmission of the second wavelength, and a third spectral filter corresponding to the third portion of F(H) and allowing transmission of the third wavelength. The spectral filters may be similar to those discussed above with reference to FIG. 2 when the spatial filter is configured to filter polychromatic light. In this way, the first, second and third image fields can be displayed at the viewer's pupil simultaneously, without the need for time-sequential synchronisation of an illumination source and/or shutters of a spatial filter.

In examples, the first, second and third wavelengths correspond to red, green and blue light respectively. Red may have a wavelength between 610 nm-750 nm such as 635 nm. Blue light may have a wavelength around 400 nm-495 nm, for example, 450 nm. Green light may have a wavelength in the range of 495 nm-570 nm or in the range of 520 nm-560 nm, such as around 520 nm.

The second portion 310 is larger than the first and third portion 308, 312. This means that more green light can be transmitted by the spatial filter compared to red and blue light. Receptors in the eye are most sensitive to green light, so this arrangement provides an effective improvement of the display quality as perceived by a viewer because green light has a higher effective resolution than red and blue light.

In this example, the second portion 310 is a rectangle having a width equal to ⅔ the inter-order distance 306 and a height equal to ½ the inter-order distance 306. The area occupied by the second portion 310 is therefore ⅓ the area of a unit cell in the Fourier domain. The first and third portions 308, 312 are equally sized rectangles having a height equal to ¼ the inter-order distance 306 and width equal to ⅓ of the inter-order distance 306. The area occupied by each of the first and third portions 308, 312 is therefore 1/12 the area of a unit cell in the Fourier domain.

FIG. 3 depicted a decomposition in the Fourier domain. FIG. 4 shows an example physical (real world) spatial filter 400 corresponding to the decomposition 300 of FIG. 3 in physical space (a Fourier plane of the optical system). The arrangement of first, second and third regions 404, 406, 408 therefore corresponds to the physical locations of the first, second and third portions 308, 310, 312 shown in the frequency domain in FIG. 3. The location of the zero-order diffraction peak 402 is shown as well as the blocking region 410 of the spatial filter 400 that always prevents light from passing. As can be seen, in physical space, the blue region 408 partially overlaps with the green region 406 and red region 404. In the overlaps, the spatial filter simultaneously allows the transmission of blue and green light, and blue and red light respectively.

In the example of FIG. 4, the light sources are arranged such that the zero-order diffraction peaks 402 corresponding to each colour are aligned in the Fourier plane. In one example, the light sources are provided by an emitter of white light with suitable spectral filtering, before or after the SLM. In another example, the light sources may be provided by separate emitters with suitable wavelengths. Wavelength scaling then adjusts the relative position and size of the apertures.

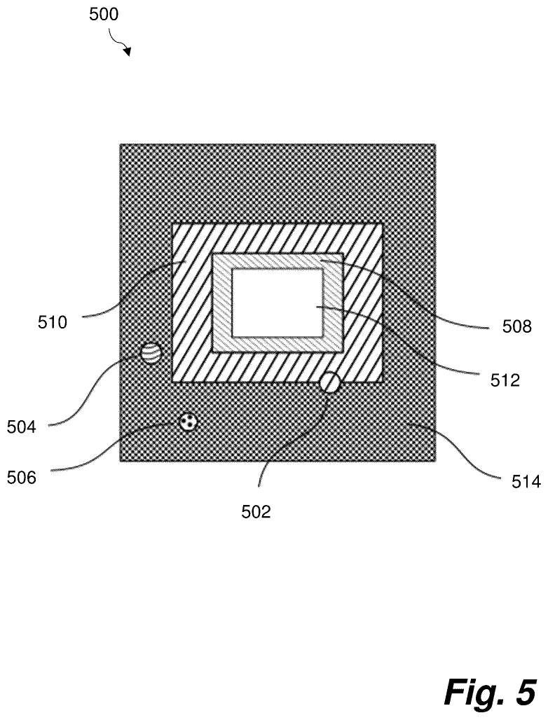

FIG. 5 shows a physical spatial filter 500 having another arrangement of three regions 508, 510, 512 compared with the arrangement of the regions 404, 406, 408 in the spatial filter 400 shown in FIG. 4, and also corresponding to the decomposition 300 of FIG. 3 in physical space. In this example, the illumination angles of the three light sources incident on the SLM are set such that the zero-order diffraction peaks for green 502, red 504 and blue 506 are in locations which result in the regions corresponding to green, red and blue light being approximately aligned, so that the centre of each aperture 508, 510, 512 is approximately coincident. Referring to the display system 100 shown in FIG. 1, this can be achieved by adjusting the offset and/or angle of the light sources (in the illumination system 102) before the condenser lens 104.

The spatial filter 500 comprises a second region 510 corresponding to the second portion that allows the transmission of green light. The spatial filter 500 further comprises a first region 508 corresponding to the first portion that allows the transmission of red light. The third region 512 allows the transmission of blue light. Where these regions 510, 508, 512 overlap, the filter has the colour of the sum of the colours required. Thus, in the outer part of the filter where region 510 is not overlapped with any other region, only green light is allowed to pass and the physical filter appears green. In the intermediate part where 510 and 508 overlap with one another, the physical filter allows green and red light to pass but blocks blue light, so the filter appears yellow. Further, in the central part of the filter where all of the green, red and blue regions overlap, the filter allows green, red and blue light to pass, so the filter appears white or transparent. Thus, the central part of the spatial filter that appears white may be realised as an aperture without any spectral filters. In other words, the part corresponding to the overlap of regions 508, 510 and 512 may be simply a hole in the spatial filter 500 or a transparent or clear section. As before, a blocking region 514 prevents passage of light outside the first, second and third regions.

Aligning the regions 508, 510, 512 as in FIG. 5 reduces the extent of the Fourier plane occupied by the union of the regions 508, 510, 512. This may allow more effective eyebox alignment. Aligning the light transmitted by the overlapping regions 508, 510, 512 with a viewer's pupil ensures that a viewer will receive light of each colour. In contrast, it may be more challenging to align the spatial filter 400 shown in FIG. 4 so that all of red, green and blue light is received by a viewer's eye. Furthermore, the arrangement of regions 508, 510, 512 in the spatial filter 500 shown in FIG. 5 allows more of the Fourier plane to be utilised for other purposes. An example is discussed later with reference to FIG. 12.

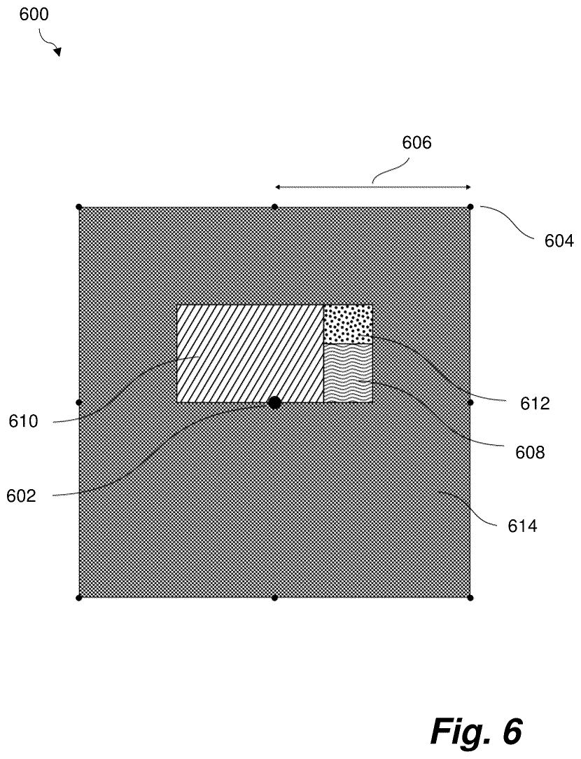

FIG. 6 shows a further example decomposition 600 of part of the spatial frequency domain. The decomposition 600 delimits first, second and third portions 608, 610, 612 positioned with respect to the zero-order diffraction peak 602, the first horizontal and vertical diffraction peak 604 and the inter-order distance 606.

The second portion 610, corresponding to green light, is larger than the first and third portions 608, 612, corresponding to red and blue light respectively in order to prioritise the more perceptually important green light, as discussed above. Furthermore, the first portion 608 is larger than the third portion 612. This allows more red light to pass through than blue light. Red light is more perceptually important than blue to the human eye so this configuration of the portions in the Fourier domain may give improved image quality of the arrangement of FIG. 3 where red and blue have equal areas. As before, a portion 614 corresponds to a blocking region that prevents the transmission of light.

The union of portions 608, 610, 612 again occupies an area equal to half a unit cell in the Fourier domain to avoid any overlap between F(H) and the noise components when using an amplitude-modulating SLM. In this example, the second portion 610 is a rectangle having a width equal to ¾ the inter-order distance 606 and a height equal to ½ the inter-order distance 606. The area occupied by the second portion 610 is therefore ⅜ the area of a unit cell in the Fourier domain. The first portion 608 is a rectangle having a height equal to 3/10 the inter-order distance 606 and width equal to ¼ of the inter-order distance 606. The area occupied by the first portion 608 is therefore 3/40 the area of a unit cell in the Fourier domain. The third portion 612 is a rectangle having a height equal to ⅕ the inter-order distance 606 and width equal to ¼ of the inter-order distance 606. The area occupied by the third portion 612 is therefore 1/20 the area of a unit cell in the Fourier domain.

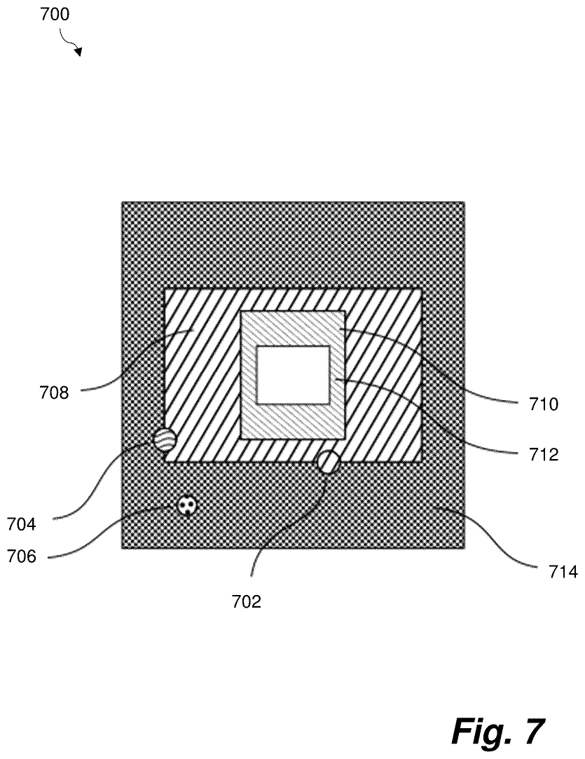

FIG. 7 shows a real-world physical spatial filter 700 corresponding to the decomposition 600 shown in FIG. 6 in physical space and wherein the zero-order diffraction peaks for green 702, red 704 and blue 706 sources are arranged so that regions corresponding to green 708, red 710 and blue 712 are approximately aligned, in the same way as in FIG. 5. In the display system 100 shown in FIG. 1, this can be achieved by adjusting the position and/or angle of the light sources (in the illumination system 102) before the condenser lens 104. Again, a blocking region 714 of the spatial filter 700 is shown.

Aligning the green, red and blue regions 708, 710, 712 has similar benefits to the spatial filter 500 shown in FIG. 5. However, the spatial filter 700 shown in FIG. 7 has the further benefit that the image field corresponding to red light is displayed at a higher resolution than the image field corresponding to blue light, improving overall image quality because red light is more perceptually important to the human eye than blue light.

As discussed so far, the largest dimensions of the portions in the Fourier domain (and the corresponding regions in the physical filter for positioning in a Fourier plane of an optical system) are not aligned with either of the directions of consecutive horizontal or vertical diffraction orders. A “largest dimension” is the longest straight line that can fit within the area, for example in the case of rectangle or square it is the diagonals. This may mean that some higher horizontal and vertical spatial frequencies will be filtered out. While this is acceptable in many cases, there are some image fields wherein it may be beneficial to allow transmission of higher spatial frequencies. An example is the display of text content which is typically composed of higher horizontal and vertical spatial frequencies.

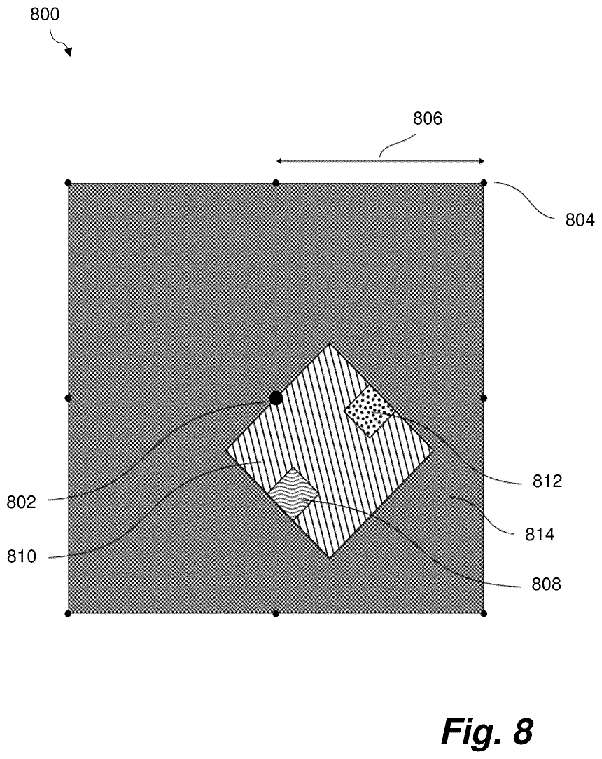

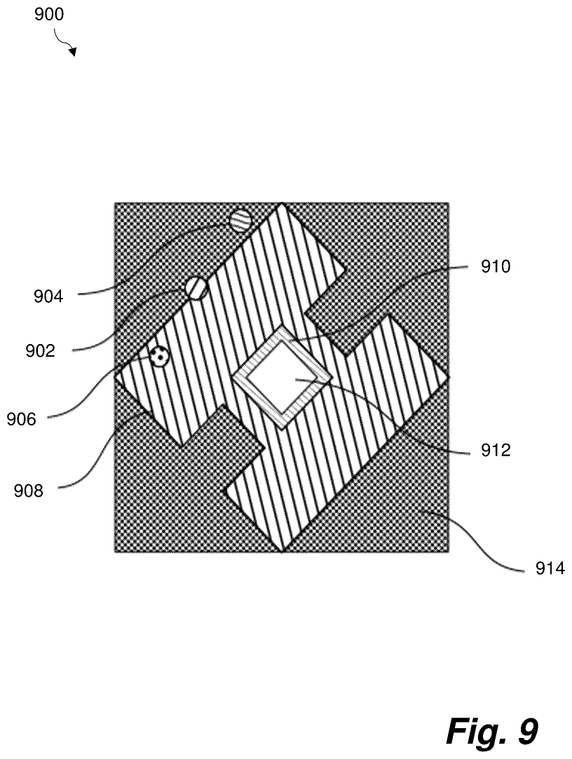

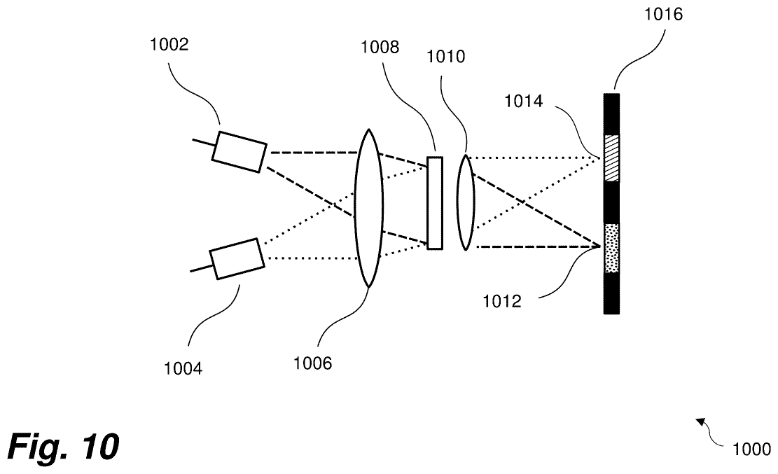

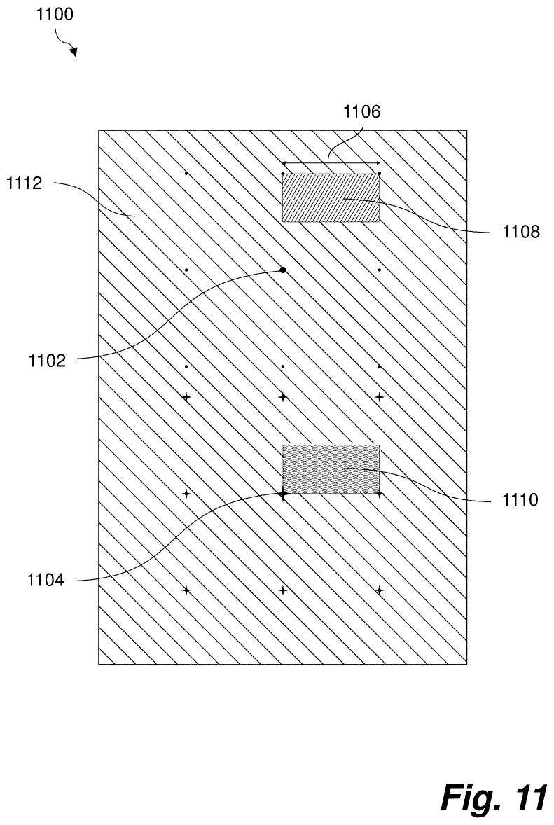

FIG. 8 shows an example decomposition 800 in the Fourier domain. The decomposition 800 again delimits first, second and third portions 808, 810, 812 positioned with respect to the zero-order diffraction peak 802, the first horizontal and vertical diffraction peak 804 and the inter-order distance 806. The decomposition 800 may be used to simultaneously transmit RGB image fields in a similar manner as discussed above for FIG. 3. As in those examples, a portion 814 corresponds to a blocking region that prevents the transmission of light. This example is also suitable for use with an amplitude modulating SLM, so that F(H) does not overlap its conjugate F(H*).

Each of the first, second and third portions 808, 810, 812 have shapes with a largest dimension that is aligned with a direction of consecutive horizontal and vertical diffraction orders in the Fourier plane. In particular, the first and third portions 808, 812 are squares that are rotated 45 degrees so that the diagonals are aligned with the direction of consecutive horizontal and vertical diffraction orders. The second portion 810 has a shape of a tilted “I” or “H” such that the largest dimensions of the shape are aligned with the direction of consecutive horizontal and vertical diffraction orders. In addition, the union of portions forms a square that is rotated 45 degrees. The decomposition 800 allows higher vertical and horizontal frequencies to be transmitted, which as discussed above may be beneficial where images composed of higher spatial frequencies are to be displayed, such as text content.

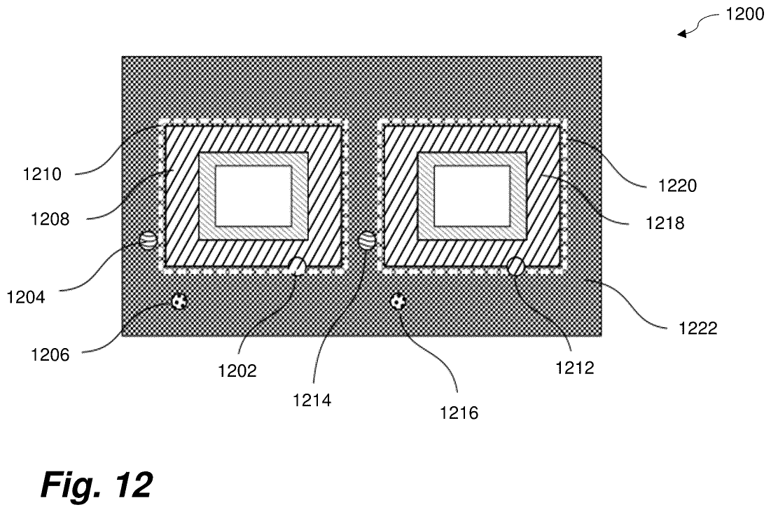

FIG. 9 shows a physical spatial filter 900 corresponding to the decomposition 800 shown in FIG. 8. The zero-order diffraction peaks for green 902, red 904 and blue 906 sources are arranged so that regions corresponding to green 908, red 910 and blue 912 are approximately aligned. As previously mentioned, this can be achieved in the display system 100 shown in FIG. 1 by adjusting the position and/or angle of the light sources (in the illumination system 102) before the condenser lens 104. Again, a blocking region 914 of the spatial filter 900 is shown.

Aligning the green, red and blue regions 908, 910, 912 has similar benefits to the spatial filters 500, 700, shown in FIGS. 5 and 7 respectively, relating to more effective eyebox alignment and lower Fourier plane occupancy. However, the spatial filter 900 shown in FIG. 9 has the further benefit that higher horizontal and vertical spatial frequencies can be transmitted compared to those filters, making the spatial filter 900 better for displaying text.

FIG. 10 is a schematic diagram of an example display system arrangement 1000 demonstrating how multiple sources may illuminate an SLM from different angles to achieve spatially-separated zero order diffraction peaks, as shown in FIGS. 5, 7 and 9. Two sources are shown for clarity, but the principles described here apply to any number of sources. The display system 1000 comprises a first light source 1002 and a second light source 1004. The display system 1000 further comprises a condenser lens 1006 arranged to produce approximately collimated light from the first and second light sources 1002, 1004 and illuminate an SLM 1008. The SLM 1008 is configured to form a modulation pattern that generates a light field, H. An optical system 1010 is arranged to generate a Fourier transform of the light field generated by the SLM 1008 F(H) in a Fourier plane of the SLM 1008. A spatial filter 1016 is positioned in the Fourier plane.

The first and second light sources 1002, 1004 may be configured to generate at least partially coherent light at different wavelengths or approximately the same wavelength. The SLM 1008 is configured to form a single modulation pattern representing two image fields simultaneously. Each of the two image fields correspond to light emitted by a single of the first and second light sources 1002, 1004. It is thus important that the first and second light sources 1002, 1004 are mutually incoherent so that coherent interference between light emitted by the different light sources 1002, 1004 is avoided. This can be achieved when the light sources emit light at different wavelengths due to differences in spatial and temporal coherence, and by light sources emitting light at approximately the same wavelength but which are mutually spatially incoherent.

The first and second light sources 1002, 1004, condenser lens 1006, SLM 1008, and optical system 1010 are arranged so that the zero-order diffraction peaks 1012, 1014 of the light emitted by different light sources 1002, 1004 are located at a spatially distinct region of the Fourier plane where the spatial filter 1016 is positioned. The locations and/or illumination angles of the first and second light sources 1002, 1004 can be adjusted such that the zero order of each source is located at the desired position in the Fourier plane as shown in FIGS. 5, 7 and 9.

So far, spatial filters featuring partitions of the Fourier domain have been described wherein the mutual incoherence is achieved either through the use of controllable time-sequential apertures for a single wavelength and the use of the spectral filters for multiple wavelengths. The arrangement illustrated in FIG. 10 provides further means by which the Fourier plane can be partitioned in a mutually incoherent manner using light of a single wavelength. In this example, the two light sources 1002, 1004 may be configured to generate light at approximately the same wavelength in a mutually incoherent manner.

FIG. 11 shows a physical spatial filter 1100 in an example display system, for example the display system 1000 shown in FIG. 10. The spatial filter 1100 also corresponds to the spatial frequency domain decomposition 200 in FIG. 2, in physical space. The arrangement of the display system is such that the zero-order diffraction peak of light from a first light source 1102 is targeted at a first position in the Fourier plane, while the zero-order diffraction peak of light from a second light source 1104 is targeted at a second position in the Fourier plane that is different from the first position. The unit cell of the Fourier domain, defined by contiguous diffraction orders, is the same size for each light source (because they are emitting light at the same wavelength) and defined by the inter-order distance 1106.

An SLM is configured to generate a single modulation pattern representing two image fields (as has been discussed throughout). The image fields in this example are separated by a gap in the Fourier plane; a first region 1108 of the spatial filter corresponding to a first portion of F(H) 208 (corresponding to a first image field) is positioned in the upper half portion of a unit cell with respect to the zero-order diffraction peak of light from the first light source 1102, while a second region 1110, corresponding to a second portion of F(H) 210 (corresponding to a second image field) is positioned in the lower half portion of a unit cell with respect to the zero-order diffraction peak of light from the second light source 1102. The spatial filter 1100 would further comprise a blocking region to prevent light passing in other regions.

The shapes of the regions 1108, 1110 correspond to the decomposition 200 shown in FIG. 2, but it is understood that this principle applies to any shape. Furthermore, more than two light sources could be used, and the light sources need not emit light at approximately the same wavelength. Similar controllable shutters to those discussed with regards to FIG. 2 may be used for light emitted by each of the light sources to increase the area of the Fourier plane utilised in order to expand the eyebox of the display system. A further technique for eyebox expansion will be discussed below.

### Eyebox Expansion

Increasing the number of image fields that can be displayed per unit time provides more capacity for doing time-sequential eyebox expansion. This provides an opportunity to expand the size of the eyebox of the display system by using nearby unutilised regions of the Fourier plane to display different frames of the SLM time-sequentially.

In this example, a spatial filter delimits multiple sets of regions, with each set associated with a switchable shutter to allow for a single set of regions to allow light to pass at any one time. Each set of regions may have an associated light source (or set of light sources), which may be configured only to emit light when the switchable shutter for the corresponding set of regions is set to allow light to pass. The switchable shutter may use a similar technology to that discussed with regards to the controllable shutters in the example of FIG. 2. In some examples, the switchable shutters may actually be the controllable shutters so that they are used for both time-sequential Fourier plane partitioning of a single SLM frame, as well as for eyebox expansion using multiple SLM frames.

An example of eyebox expansion via the use of time-sequential controllable shutters will now be discussed with reference to FIG. 12 which shows an example spatial filter 1200, in physical space, and delimiting a first set of regions 1208 and a second set of regions 1218. Each of the sets of regions 1208, 1218 correspond to the arrangement of regions 508, 510, 512 in FIG. 5. This is for illustration purposes; it is understood that each set of apertures could comprise any arrangement of apertures, and need not necessarily be the same. In some examples, the sets of regions may overlap where the colours are compatible. For example, the green regions of 1208 and 1218 corresponding to region 510 in FIG. 5 may overlap. In this instance, the switchable shutters may correspondingly overlap.

Both the first and second set of apertures 1208, 1218 comprise spectral filters similar to those described with reference to FIG. 5 so that green, red and blue light are selectively filtered. To achieve the relative targeting of green, red and blue light for each of the sets of regions 1208, 1218, six light sources are used. For the first set of apertures, first, second and third light sources are arranged so that the zero-order diffraction peaks of green 1202, red 1204, and blue 1206 light are positioned such that the particular alignment of apertures, corresponding to the respective colours, is generated. Similarly, for the second set of apertures, fourth, fifth and sixth light sources are arranged so that the zero-order diffraction peaks of green 1212, red 1214, and blue 1216 light are positioned such that the particular alignment of apertures, corresponding to the respective colours, is generated.

The first and second sets of regions 1208, 1218 are surrounded by respective shutter boundaries 1210, 1220 with light outside the sets of regions not allowed to pass by a blocking portion 1222 of the spatial filter 1200.

In operation, at a first time, a first controllable shutter associated with the first set of regions 1208 allows light to pass through the first set of regions 1208. At the first time, a second controllable shutter associated with the second set of regions 1218 is in a state so that light cannot pass through the second set of regions 1218. At a second time, the first controllable shutter associated with the first set of regions 1208 does not allow light to pass. At the second time, the second controllable shutter associated with the second set of regions 1218 allows light to pass through the second set of regions 1218.

At the first time, the SLM is configured to form a first modulation pattern that generates a first light field comprising first, second and third image fields. The first light field is generated by the first, second and third light sources and is targeted so that the targeted portions of the Fourier domain correspond to the first set of regions 1208. At the second time, the SLM is configured to form a second modulation pattern that generates a second light field comprising fourth, fifth and sixth light fields. The second light field is generated by the fourth, fifth and sixth light sources and is targeted so that the targeted portions of the Fourier domain correspond to the second set of regions 1218.

It is understood that this example could be extended to any number of sets of apertures and associated controllable shutters. Furthermore, this technique is not limited to the simultaneous display of polychromatic light, but could be used with any of the incoherent partitioning examples discussed herein to increase the effective size of the eyebox.

### Using Different Portions of the Spatial Frequency Domain

As discussed so far, the proposed spatial filters use an area of the spatial-frequency domain, such as the Fourier domain, which is the same for each of the single modulation patterns formed on the SLM. Put another way, all the single modulation patterns described so far, and corresponding spatial filters, target the same portion of the spatial-frequency domain each time. However, the present disclosure is not limited to this, and examples will now be described whereby different parts of the spatial-frequency domain are targeted by different single modulation patterns on the SLM. For example, a first single modulation pattern comprises a first plurality of image fields targeting a first portion of the spatial-frequency domain and a second single modulation pattern comprises a second plurality of image fields targeting a second portion of the spatial frequency domain, different from the first portion.

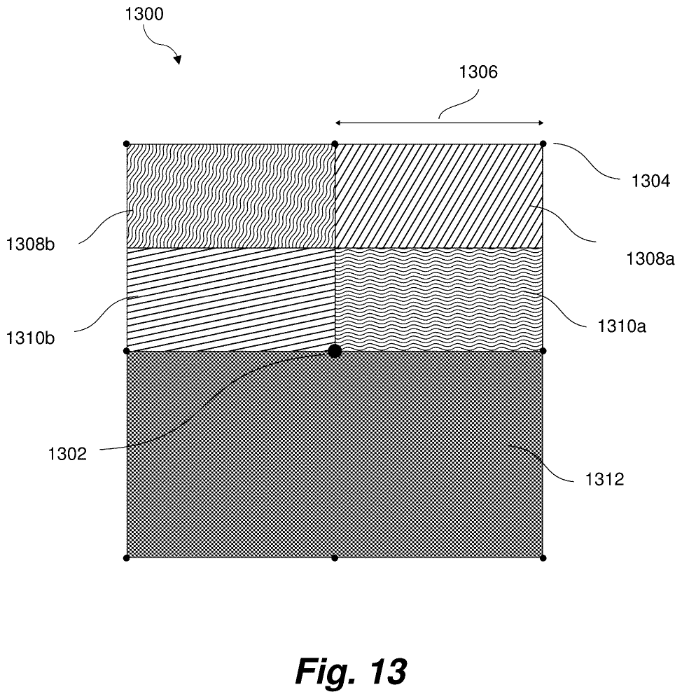

Referring to FIG. 13, two decompositions in the Fourier domain are shown. Both decompositions are similar to the construction of FIG. 2 and include a zero-order diffraction peak 1302. Higher order diffraction peaks, such as first-order diffraction peak 304, form a grid of unit cells in the Fourier domain. Just as with FIG. 2, there is an inter-order distance 1306. As can be seen, two unit cells are used for targeting image fields. A first set of portions 1308a, 1310a correspond to the portions 208 and 210 in FIG. 2. Another unit square is used for a second set of portions 1308b, 1310b targeting a different portion of the Fourier domain. A portion 1312 is not used and is blocked throughout.

Each set of portions can be controlled to allow light to pass or to block light, for example by using liquid crystal shutters or other constructions discussed above. In use, the SLM forms a first single modulation pattern with two component image fields targeting the first set of portions 1308a, 1310a. Light from the second set of portions 1308b, 1310b is blocked and light from the first set of portions is allowed to pass. Next, the SLM forms a second modulation pattern with two component image fields targeting the second set of portions 1308b, 1310b. Light from the first set of portions 1308a, 1310a is blocked and light from the second set of portions 1308b, 1310b is allowed to pass. As described above for FIG. 2, the portions within each set can be mutually incoherent in various ways. For example by using different wavelengths and a spatial filter with spectral filtering, or by time domain shuttering within each set during the display period of the single modulation pattern.

The example of FIG. 13 allows the same light source to target a different portion of the spatial-frequency domain, such as to expand an eyebox, while retaining the advantages of increased image fields per unit time.

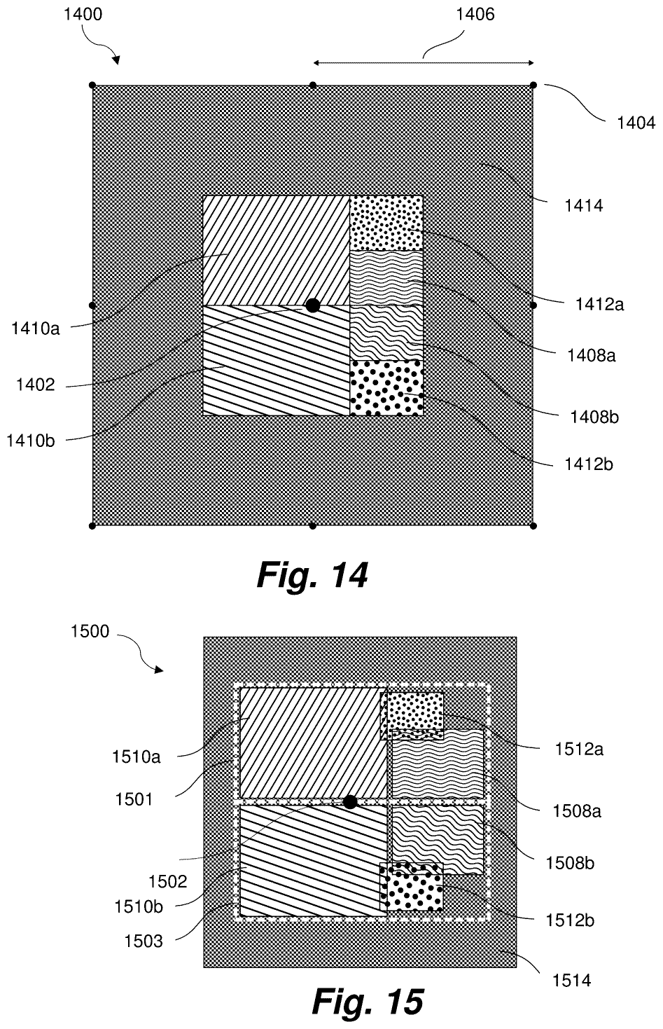

Moving now to FIGS. 14 and 15, the principles of FIG. 13 are applied to the RGB portions and regions of FIGS. 3 and 4 above. FIG. 14 shows how the portions are targeted in the space-frequency or Fourier domain and FIG. 15 shows the resulting physical spatial filter for positioning in a Fourier plane of an optical system, accounting for wavelength scaling and diffraction effects.

Referring to FIG. 14, in the Fourier domain there is a zero-order diffraction peak 1402, a first-order diffraction peak 1404 and an inter-order spacing 1406. The decomposition 1400 comprises two sets of portions: a first set 1408a, 1410a, 1412a and a second set 1408b, 1410b, 1412b. Within each set, the first portion 1408a, 1408b is for red light, the second portion 1410a, 1410b is for green light and the third portion 1412a, 1412b is for blue light. A remaining portion 1414 is always blocked.

The corresponding physical filter for positioning in a Fourier plane of an optical system is depicted in FIG. 15. The boundary of the first set is shown at 1501 and the boundary of the second set is shown at 1503. Within each set, spectral filter regions 1508a, 1510a, 1512a and 1508b, 1510b, 1512b ensure a respective wavelength targets the relevant part of the Fourier plane. Each set is also provided with a shutter or other construction that is controlled to allow light to pass or to block the passage of light, for example shutters extending over the whole area of a respective sets of spectral filter regions as depicted by boundaries 1501 and 1503, respectively.

In use, the SLM forms a single modulation pattern with three component image fields targeting the first set of portions 1408a, 1410a, 1412a. The second set of regions 1503 are controlled to block light and the first set of regions 1501 are controlled to allow light to pass. Next, the SLM forms a second modulation pattern with three component image fields targeting the second set of portions 1408b, 1410b, 1412b. The first set of regions 1501 of the physical spatial filter 1500 are controlled to block light and the second set of regions 1503 are controlled to allow light to pass.

In this way, the advantage of increased numbers of light fields per unit time can be combined with increased coverage of the space-frequency or Fourier domain, such as to expand an eyebox, without requiring additional illumination sources.

Although the examples of FIGS. 13 to 15 build on the examples of FIGS. 2 to 4, the principle of expanding covering of the space-frequency or Fourier domain without an additional illumination source through different single modulation patterns targeting different portions of the space-frequency domain can be applied to any of the examples discussed herein.

### White Image Fields

The above example filters have considered a decomposition of an image into red, green and blue (RGB) image fields. The present disclosure is not limited to this, and examples will now be described which include a decomposition including a white image field. Including a white image field may improve image quality of white and grey areas as these will exhibit less chromaticity variation than when white is formed by adding red, green and blue fields alone. The human eye is more sensitive to chromaticity variation than luminance variation, so reducing chromaticity variation improves perceived image quality.

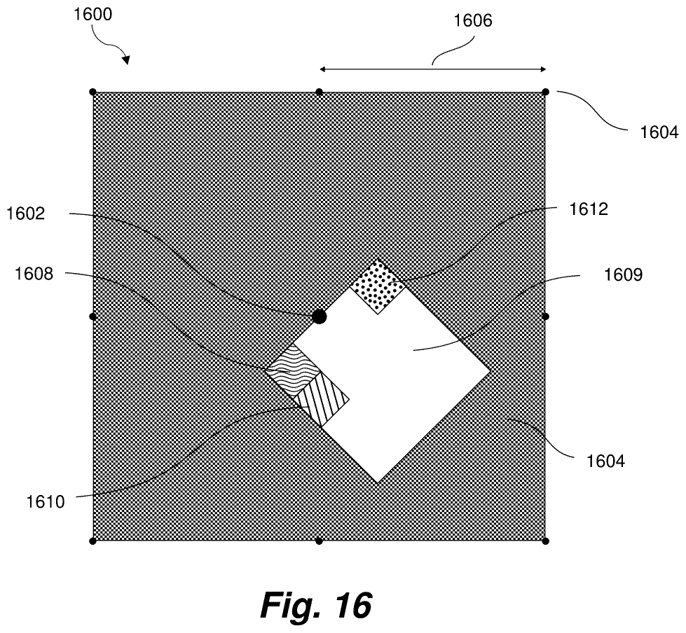

FIG. 16 depicts an example decomposition 1600 of the Fourier domain into red, green, blue and white (RGBW) image fields. There is a zero-order diffraction peak 1602, a first-order diffraction peak 1604 and an inter-order spacing 1606. The decomposition 1600 comprises four portions: a first portion 1608 is for red light, a second portion 1609 is for white light, a third portion 1610 is for green light and a fourth portion 1612 is for blue light. A remaining portion 1614 is always blocked.

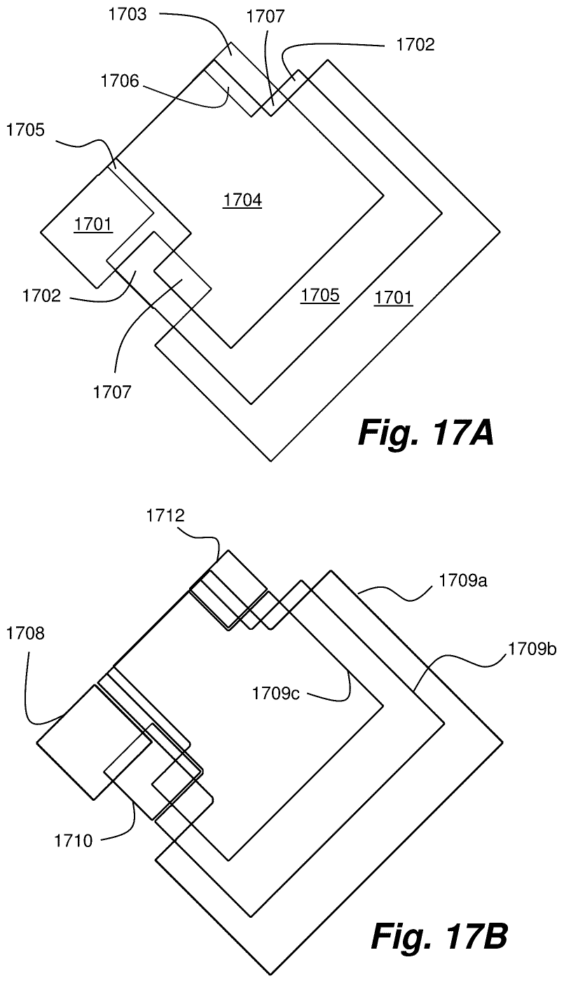

FIG. 17A depicts the colour parts of a physical filter corresponding to the decomposition of FIG. 16. The physical filter is for positioning substantially in a Fourier plane of an optical system. FIG. 17B is a diagrammatic representation of regions of the physical filter which pass light corresponding to the portions in the Fourier Domain.

Referring to FIG. 17B, the red portion, green portion and blue portion in the Fourier domain correspond to the square regions 1708, 1710 and 1712 in FIG. 17B. As the white portion in the Fourier domain is for white light, the broadband nature means that diffractive wavelength effects should be considered, meaning that the corresponding region of the physical filter is larger for longer wavelengths. In this example, the filter is determined by considering the white region as comprising red, green and blue instances 1709a, 1709b and 1709c, with each instance scaled appropriately. In other words, the white region corresponding to the white portion of the Fourier domain is made up of instances 1709a, 1709b and 1709c. The largest instance 1709a passes red light corresponding to the white portion of the Fourier domain, the middle-sized instance 1709b passes green light corresponding to the white portion of the Fourier domain, and the smallest instance 1709c passes blue light corresponding to the white portion of the Fourier domain. Where these various regions 1708, 1710, 1712 and instances 1709a, 1709b, 1709c overlap, the filter has the colour of the sum of the overlapping colours. Thus, the physical filter includes not just red, green, blue and white parts but yellow and cyan parts too. Referring to FIG. 17A, the filter comprises red parts 1701, green parts 1702, a blue part 1703, a white part 1704, yellow parts 1705, a magenta part 1706 and cyan parts 1707.

The filter of FIG. 17A may be produced in any suitable manner, such as by printing using red, green and blue inks alone or in combination to define the coloured regions on the slide. Similarly, cyan, magenta, and yellow inks may be used which block red, green and blue light respectively for a subtractive colour system. Dedicated inks for the colour required in each region may also be used. Other ways of producing the filter are possible, such as dielectric coating or a surface treatment.

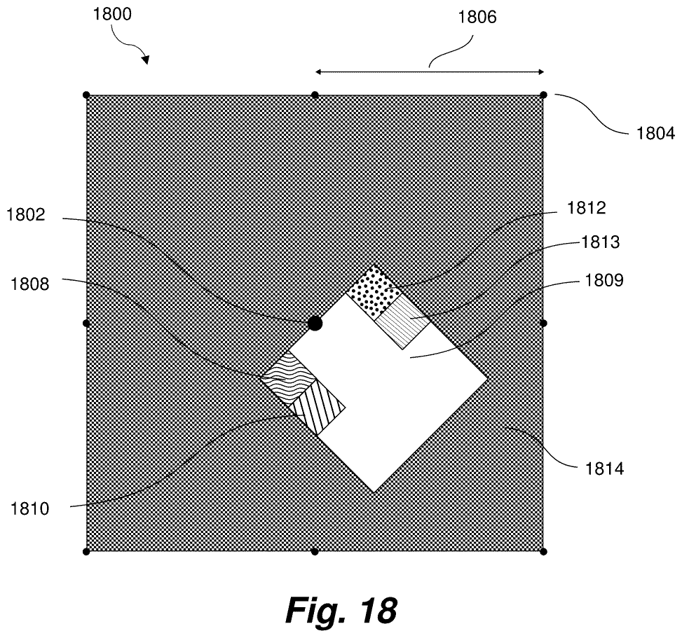

FIG. 18 depicts another example decomposition 1800 of the Fourier domain, this time into red, green, blue, white and yellow portions. The red, green and blue portions are the same as FIG. 16, and a yellow portion is added by reducing the area of the white portion compared to FIG. 16. All of the red, blue, green and yellow portions have the same area in Fourier domain (as depicted).

As with the decomposition depicted in FIG. 16, the decomposition 1800 of FIG. 18 shows a zero-order diffraction peak 1802, a first-order diffraction peak 1804 and an inter-order spacing 1806. The decomposition 1800 comprises five portions: a first portion 1808 is for red light, a second portion 1809 is for white light, a third portion 1810 is for green light, a fourth portion 1812 is for blue light, and a fifth portion 1813 for yellow light. A remaining portion 1814 is always blocked.

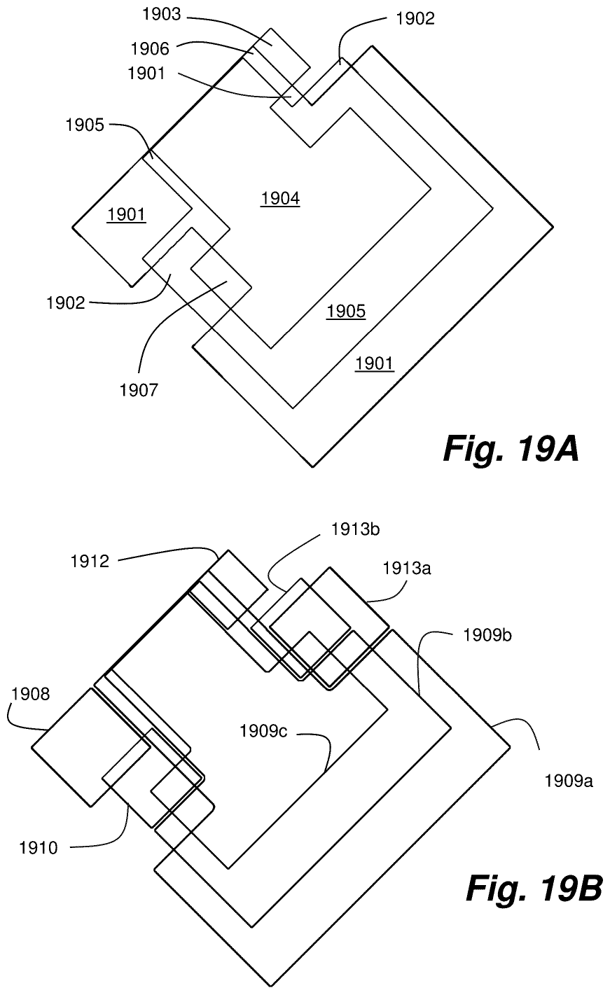

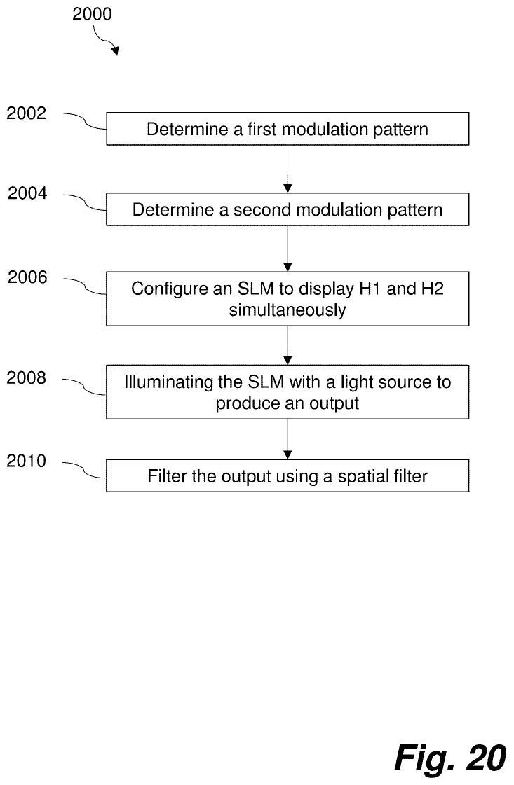

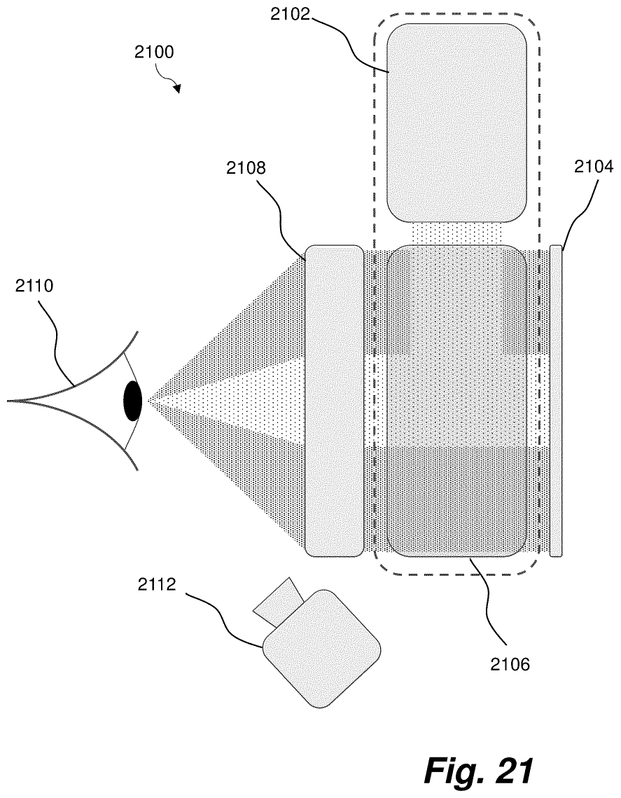

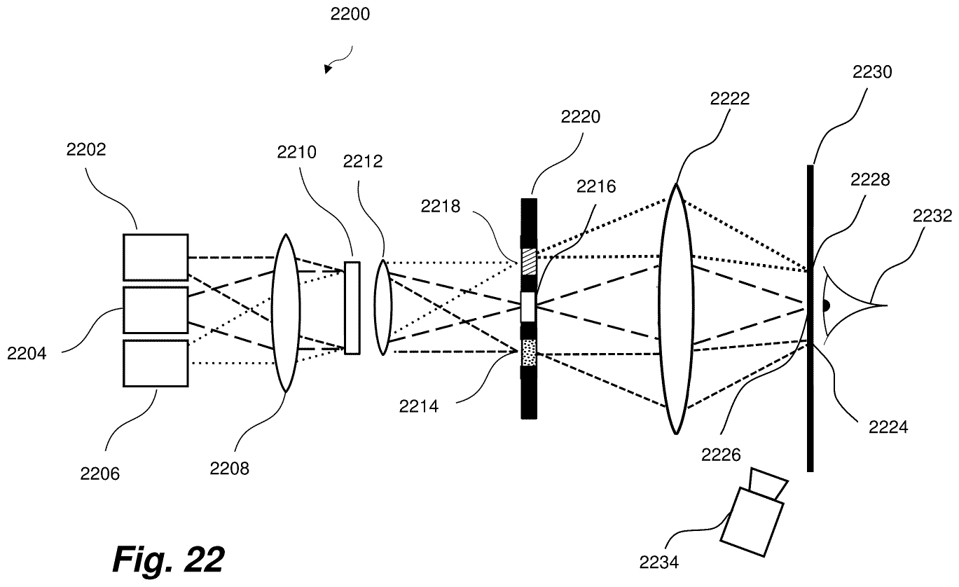

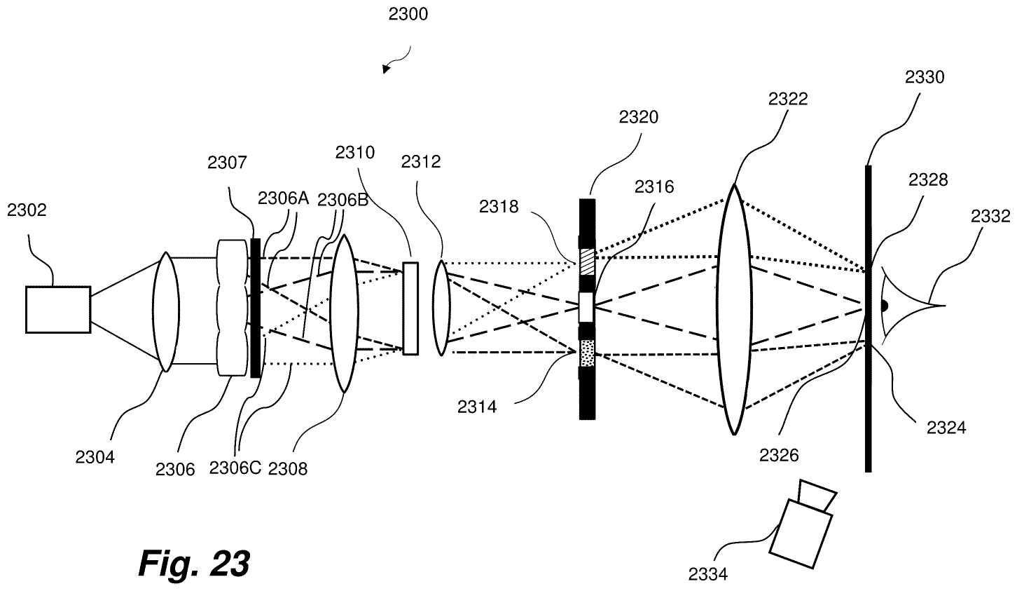

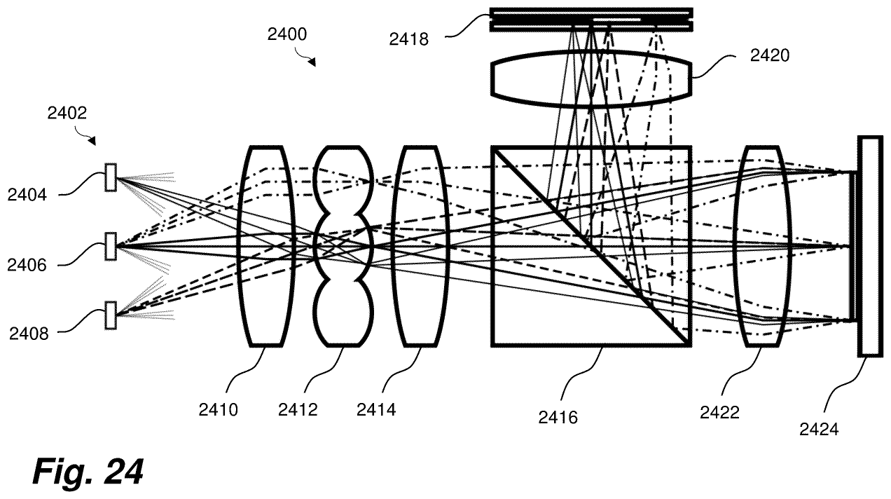

The colour parts of a physical filter corresponding to the decomposition of FIG. 18, and for positioning in a Fourier plane of an optical system, are depicted in FIG. 19A. FIG. 19B is a diagrammatic representation of regions of the physical filter which pass light corresponding to the portions in the Fourier Domain. The red portion, green portion, and blue portions correspond to the square regions 1908, 1910, 1912 in FIG. 17B. In this example, the filter region corresponding to the white portion of the Fourier domain is again determined by considering it to be comprising red, green and blue instances, with each instance scaled appropriately in the same way as described above for FIG. 17B. Thus, the largest instance 1909a passes red light, the middle-sized instance 1909b passes green light and the smallest 1909c passes blue light. Similarly, in this example the filter region corresponding to the yellow portion of the Fourier domain is considered as comprising red and green instances 1913a and 1913b respectively. In a different example, the filter region corresponding to the yellow portion of the Fourier domain could be considered as a single instance and scaled with a dominant yellow wavelength. Where these various regions 1908, 1910, 1912 and instances 1909a, 1909b, 1909c, 1913a, 1913b overlap, the filter has the colour of the sum of the colours required. Thus, the physical filter includes not just red, green, blue, white and yellow parts but cyan and magenta parts too. Referring to FIG. 19A, the filter comprises red parts 1901, green parts 1902, blue part 1903, white part 1904, yellow parts 1905, magenta part 1906 and cyan part 1907.

Unlike with the regions of FIG. 17, where a yellow part corresponded with a requirement to pass red and green light, in the filter of FIG. 19A, parts that appear yellow can be present for different underlying colours. For example:
(i) a part of the filter comprising an overlap of red and green regions (which may appear yellow) must transmit wavelengths corresponding to both the red and green portions, but could potentially fully or partially block wavelengths corresponding to the yellow portion.
(ii) a part of the filter comprising a yellow region must transmit wavelengths corresponding to the yellow portion (but could potentially fully or partially block wavelengths corresponding to the red and/or green portion)

When using a printed spectral filter with a CMY printing process, a single Y ink may significantly transmit light corresponding to each of the red, green and yellow portions, thereby satisfying both requirements. Other examples may also use different inks for the two different filtering requirements.

Some examples may use a spectral filter which is printed with inks having properties matched to the filtering requirements of a particular part of the physical slide. In the case, the inks might include: (i) a dedicated yellow ink, such as a slide that lets through a particular yellow wavelength; (ii) a specific ink allowing red and green wavelengths to pass, but (probably) blocking out some intermediate yellow wavelengths (this would increase saturation of red and green); and (iii) an ink that lets through all red wavelengths, and varying levels of orange/yellow/green/cyan wavelengths, for use in regions corresponding to the wavelength dependent effects of the white region and improve transmission efficiency.

In the examples above, the physical filter was designed by considering some regions, such as the white region and the yellow region, to be sum of other colours so that diffractive effects are correctly accounted for. Other examples may use a different approach, such as modelling more constituent colours or considering a continuum of colours and corresponding scaled components for the diffractive effects. However, the design process here has been found to give a good balance between filter complexity and image quality.

In the examples above, the Fourier domain decomposition is shown contiguous with the zero order. Other examples may have a blocked region in vicinity of the zero order to block more of the zero order.

Given a design for the Fourier domain partitioning, the physical filters depicted in FIGS. 17A and 19A have been produced for a system which displays primarily red, green and blue wavelengths. It is understood that an illumination system containing an additional primary wavelength peak(s) or band(s) of significance (e.g. yellow, corresponding to a wavelength between green and red) could have an additional appropriately scaled component(s).

### Example Method of Operation

Having explained the theory and overall construction of a display system according to the present disclosure, a general method of operation will now be explained. FIG. 20 shows a method 2000 of displaying multiple image fields for a single modulation pattern of an SLM. The method 2000 can be executed by a controller of the display systems 100, 1000 shown in FIGS. 1 and 10, for example. That is, the method 200 provides an example procedure for operating the display systems 100, 1000 shown in FIGS. 1 and 10.

At 2002, a first modulation pattern, H₁, corresponding to a first image field is determined. The first modulation pattern has a Fourier transform, F(H₁), that is targeted to a first region of the Fourier plane, as discussed above.

At 2004, a second modulation pattern, H₂, corresponding to a second image field is determined. The second modulation pattern has a Fourier transform, F(H₂), that is targeted a second region of the Fourier plane.

At block 2006, an SLM is configured or controlled to display H₁ and H₂ simultaneously, for example by summing H₁ and H₂.

At block 2008, the SLM is illuminated with an at least partially coherent light source in order to generate a light field representing the first and second image fields simultaneously.

At block 2010, the output is filtered by a spatial filter delimiting a first aperture corresponding to F(H₁) and a second aperture corresponding to F(H₂). Example spatial filters for this purpose have been discussed above.

### Examples to Determine Image Fields for Simultaneous Display

It will be understood that there are various ways the image fields for simultaneous display can be determined for use with the apparatus and methods described above. Some examples above use colour images, where image fields for simultaneous display can be individual colour fields, such as red, green and blue image fields.

Other examples may use the multiple image fields to reduce image noise, by generating multiple image fields that include the same image information (such as a same scene from a same viewpoint) but with different noise patterns that then average at the viewer's eye increasing image quality.

Where a shutter is provided, image fields can be displayed sequentially for motion smoothing techniques. Multiple image fields may be gathered from the image source for display directly when they are generated sequentially at a fast enough rate (typically computer games can generate very high framerates and video may be pre-recorded or rendered at a high frame rate). When the source frame rate is lower than the number of image fields to be displayed per unit time, additional image fields may also be generated through interpolation, prediction and/or machine learning techniques.

### Pupil Tracking

The above concepts have many applications in holographic and non-holographic display systems. One such example is in a virtual reality (VR) headset. A VR headset is a wearable device that immerses users in a simulated three-dimensional environment and typically consists of a head-mounted display (HMD) that covers the user's eyes and provides visual stimuli, creating the illusion of being present in a virtual world.

Eye-tracking systems in conjunction with eyebox steering mechanisms are commonly used to ensure that content is always being displayed at the viewer's pupil. One reason for the requirement of eye tracking is that eyeboxes for some holographic light fields are relatively small with respect to a viewer's average pupil size. Without eye-tracking and eyebox steering, the viewer may not be able to see images at some pupil locations. The concepts described herein provide a simpler alternative to eyebox steering as will now be discussed.

FIG. 21 shows an example VR display system 2100 comprising a combination of a holographic display 2102 and a conventional display 2104. The conventional display 2104 is configured to generate conventional 2-dimensional images and may be an LCD, an LED or an OLED display, for example. A combiner 2106 is arranged to combine the outputs of the holographic display 2102 and the conventional display 2104 and direct these at a lens 2108, or eyepiece, which focusses the outputs at a viewer's pupil 2110. The combiner 2106 allows the output of the conventional display 2104 to be transmitted without significantly affecting the output, while substantially reflecting the output of the holographic display 2102 towards the lens 2108. The combiner 2108 may comprise a beam splitter, such as a half-silvered mirror, an embedded beam splitter, or a non-replicating waveguide, for example.

As can be seen, the holographic portion of the displayed image occupies a smaller area of the field of view compared with the output of the conventional display 1704 and thus the holographic content is only present in the centre of the field of view, while lower quality conventional 2-dimensional content is present at the periphery of the field of view.

A pupil tracking system 2112 is configured to determine a location of the pupil 2110. The determined location can be used by the display system 2100 to adjust the position of an eyebox of the holographic display so that it corresponds to, i.e. is positioned over, the pupil 2110. In this way, a viewer receives image content while using the display system 2100 even as their pupil position changes.

The present disclosure provides a way to direct the eyebox of the holographic display 2102 without requiring a mechanically complex steering mechanism. Returning to FIG. 10, the spatial separation between the first and second light sources 1002, 1004 causes their respective diffraction peaks 1012, 1014 to be spatially separated in the Fourier plane. This can result in the eyeboxes occupying different positions in the pupil plane corresponding to light from the first and second light sources 1002, 1004. An arrangement for the holographic display 2102 analogous to that shown in FIG. 10, can therefore be used to control where the eyebox is positioned. While there are two sources in FIG. 10, increasing the number of sources allows a larger number of positions to be covered. Further details will now be explained with reference to FIGS. 22 and 23.

FIG. 22 illustrates an example display system 2200 comprising three illumination systems 2202, 2204, 2206. The display system 2200 further comprises a condenser lens 2208 arranged to produce approximately collimated light from the first, second and third illumination systems 2202, 2204, 2206 and illuminate an SLM 2210. The SLM 2210 is configured to form a modulation pattern that generates a light field, H. An optical system 2212 is arranged to generate a Fourier transform of the light field generated by the SLM 1810 F(H) in a Fourier plane of the SLM 2210. A spatial filter 2220 is positioned in the Fourier plane.

The first, second and third illumination systems 2202, 2204, 2206 are spatially offset from one another. In the plane of FIG. 22, the spatial offsetting is in a vertical direction, but it is also understood that spatial offsetting could be in any direction away from the plane of the Figure. In other words, defining an optical axis as an imaginary line that runs through at least the condenser lens 2208 and SLM 2210, the spatial offsetting of the illumination systems 2202, 2204, 2206 in some examples may involve spatially offsetting in at least a direction perpendicular to the optical axis. The spatial offsetting of the illumination systems 2202, 2204, 2206 causes light emitted from respective illumination systems 2202, 2204, 2206 to be incident on the SLM 2210 at different positions and/or angles.

The first, second and third illumination systems 2202, 2204, 2206 may each include one or more light sources. For example, at least one of the first, second and third illumination systems 2202, 2204, 2206 may include three light sources, with respective light sources configured to generate red, green and blue light.

Unlike the above examples, the SLM 2210 does not necessarily need to be configured to form a single modulation pattern representing multiple image fields simultaneously, although this is of course possible. Instead, in some examples, the SLM 2210 may be configured to form a modulation pattern representing a single image field at any given time.

The first, second and third illumination systems 2202, 2204, 2206, condenser lens 2208, SLM 2210, and optical system 2212 are arranged so that the zero-order diffraction peaks 2214, 2216, 2218 of the light emitted by different illumination systems 2202, 2204, 2206 are located at a spatially distinct region of the Fourier plane where the spatial filter 2220 is positioned. The locations and/or illumination angles of the first, second and third illumination systems 2202, 2204, 2206 can be adjusted such that the zero order of each source is located at the desired position in the Fourier plane, such as shown above in FIGS. 5, 7 and 9. This adjustment in location and/or angle may also be determined based on where respective images are required to be formed.

The display system 2200 comprises a further optical system 2222 to generate the inverse Fourier transform of the fields at the spatial filter 2220 at a plane 2230 in which a viewer's pupil 2232 can be positioned. This arrangement results in first, second and third images 2224, 2226, 2228 at different positions in the plane 2230. The further optical system 2222 may be referred to as the eyepiece, or main lens. The further optical system 2222 may comprise a conventional lens, a Fresnel lens, a kind of hybrid Fresnel lens wherein a central portion having a conventional lens profile and an outer portion having a Fresnel profile (e.g. featuring concentric annular sections), or a lens having a folded optical path, sometimes referred to as a “pancake” lens.

The first, second and third illumination systems 2202, 2204, 2206 may be individually switchable. For example, they may be controllable to operate in an “on” state, where at least partially coherent light is emitted, and an “off” state, where no light is emitted. The “on” state may allow the intensity of the illumination system to be varied. In use, a single one of the first, second and third illumination systems 2202, 2204, 2206 may be on at any given time, such that only a single one of images 2224, 2226, 2228 is generated in the plane 2230. Alternatively, a further filter may be present positioned near to the first, second and third illumination systems 2202, 2204, 2206 and comprising shutters that selectively let light from only one of the first, second and third illumination systems 2202, 2204, 2206 to pass at any given time. This transfers the switching capabilities of the illumination systems onto the switching capabilities of the shutters, which may be faster. Again, the result is that only a single one of images 2224, 2226, 2228 is generated in the plane 2230.

The spatial filter 2220 comprises first, second and third controllable, or switchable, shutters. The switchable shutters may use a similar technology to that discussed with regards to the shutters in the example of FIGS. 2 and 12. Each switchable shutter corresponds to a respective one of the first, second and third illumination systems 2202, 2204, 2206. In other words, a first switchable shutter may have a shape corresponding to F(H) corresponding to light originating from the first illumination system 2202. A second switchable shutter may have a shape corresponding to/(H) corresponding to light originating from the second illumination system 2204. A third switchable shutter may have a shape corresponding to F(H) corresponding to light originating from the third illumination system 1806.

The switchable shutters are configured to operate in synchrony with the “on” states of the first, second and third illumination systems 2202, 2204, 2206. Specifically, when the first illumination system is in the “on” state (or its light is allowed to pass), a corresponding switchable shutter of the spatial filter 2220 will be in the state that allows light to pass, while all other switchable shutters will be in a state that prevents light from passing. Preventing light from passing may include processes such as blocking, absorbing, or reflecting light away from an optical path. Therefore, as with the illumination systems 2202, 2204, 2206, a single one of the shutters may be in the state that allows light to pass at any given time.

Where an illumination system comprises more than one light source, a switchable shutter may include multiple sub-shutters corresponding to portions of F(H) associated with respective light sources of the illumination system. Further, the sub-shutters may be arranged or configured so that light corresponding to a first portion of F(H) does not interfere coherently with light corresponding to a second portion of F(H). If each light source of an illumination system is configured to emit light at a different wavelength, then different sub-shutters may comprise respective spectral filters allowing light of respective wavelengths to pass. In other examples, the sub-shutters may be configured to time-sequentially allow light from a respective one of the light sources of a single illumination system to pass.

An eye tracking system 2234, or pupil tracking system, is used to determine a location of the viewer's pupil 2232 in the plane 2230 in a similar manner as has been discussed with regards to FIG. 21. In an example, one of the first, second and third illumination systems 2202, 2204, 2206 whose respective image 2224, 2226, 2228 is located closest to the determined pupil location may be selected and activated, and the corresponding shutter of the spatial filter 2220 may be switched into the state that allows light to pass. The determination of which illumination system produces images closest to the determined pupil position may be performed by a processing system which is coupled to, or forms part of, the display system 2200. The processing system may also be remote from the display system 2200. The processing system may also be configured to control operation of the illumination systems and/or the spatial filter 2220 in synchrony with the determined pupil location.

As the viewer's pupil 2232 moves, different illumination systems can then be activated based on the determined pupil location. Thus, effective eyebox locating can be achieved.

In some examples, a viewer's pupil may be positioned over, or straddle, two of the images formed from respective illumination systems, so that it can view both of them. In these examples, once the pupil location is determined, a subset of less than all of the first, second and third illumination systems 2202, 2204, 2206, located near the determined pupil location (and the corresponding switchable shutters) may be time-sequentially activated at a sufficient speed that the viewer receives the multiple images but perceives a single light field due to persistence of vision. This can provide a larger effective eyebox by utilising adjacent, or at least nearby, images 2224, 2226, 2228 in quick succession to give the perception of a single larger image to the viewer. As the viewer's pupil 2232 moves, different subsets of the first, second and third illumination systems 2202, 2204, 2206 may be activated. This display system 2200 therefore provides a simpler alternative to mechanical systems that physically move elements of the display system.

The example display system 2200 illustrated in FIG. 22 comprises three illumination systems, however, it is understood that the above discussion generalises to any number of illumination systems which is at least two.

In some examples, the display system may comprise an array of light sources and each of the illumination systems may form a respective portion of the array of light sources. The array of light sources may be an LED array, for example. This may be advantageous because illumination systems remain compact and the addressable eyebox will extend over a two-dimensional area.

To cover a large area in the plane 2230 of FIG. 22, a sufficiently high number of illumination systems (e.g. light sources) are required. As more illumination systems are required, if each illumination system comprises one or more light sources, this number may become too expensive, or occupy too much space. An alternative is to replace the physical light sources within the illumination systems with images of light sources. In this way, the images of light sources within different illuminations systems may be images of the same physical light sources (referred to below as “master sources”). An example embodiment of this comprises a lens array, wherein each lens of the lens array forms an image of a set of “master sources”. Other examples are possible, such as a diffractive optical element and a collimator, or an image replicating combiner. In each of these cases, images of one or more master sources may form the multiple illumination systems.

FIG. 23 shows a further example display system 2300. The display system 2300 comprises a set of one or more master light sources 2302 configured to emit at least partially coherent light. The set of one or more master light sources 2302 may include red, green and blue light sources. An optical system 2304 (e.g. a lens) is arranged to receive light from the set of one or more master light sources 2302 and to generate approximately collimated light that illuminates a lens array 2306. The lens array 2306 may be a microlens array, such as those manufactured by Thorlabs®. The lens array 2306 illustrated in FIG. 19 comprises three lenses distributed vertically, and which are each arranged to generate respective copies of the light that illuminates the lens array 2306.

The lens array 2306 forms multiple images of the set of one or more master sources 2302 depicted by their outer rays in FIG. 19. A first image 2306A is indicated by medium-dash lines, a second image 2306B is indicated by long-dash lines, and a third image 2306C indicated by short-dash lines. Each image 2306A, 2306B, 2306C may be understood as an illumination system as discussed herein. In this way, the display system 2300 comprises three illumination systems 2306A, 2306B, 2306C formed from the set of master sources 2302 and a respective lens of the lens array 2306. Beams of light emitted by each of the illumination systems are shown using different line styles for illustration purposes.

The display system 2300 further comprises a filter 2307 comprising a plurality of controllable, or switchable, shutters, that may use a similar technology to that discussed with regards to the shutters in the example of FIGS. 2 and 12. Each of the shutters corresponds to a single one of the beams of light. Filter 2307 therefore determines which of the beams of light produced by the lens array 2307 reach the SLM 2310. In this way, it can be seen that the light source(s) 2302, optical system 2304, lens array 2306 and filter 2307 operate in a similar manner to the multiple physical light sources of the illumination systems 2202, 2204, 2206 in FIG. 22.

The display system 2300 further comprises a condenser lens 2308, an SLM 2310, a first further optical system 2312, a spatial filter 2320, a second further optical system 2322 and an eye tracking system 2234 that are the same as the condenser lens 2208, SLM 2210, optical system 2212, spatial filter 2220, further optical system 2222 and eye tracking system 2234 of the display system 2200 shown in FIG. 22. The SLM 2310 may form a modulation pattern representing one or more image fields, as has been described in detail above.

An eye tracking system 2334 is used to determine a location of the viewer's pupil 2332 in the plane 2330 in the same way as has been explained above for FIGS. 21 and 22. In an example, one of the lenses of the lens array 2306 whose respective image 2324, 2326, 2328 is located closest to the determined pupil location may be selected and activated via the filter 2307, and the corresponding shutter of the spatial filter 2320 may be switched into the state that allows light to pass. As the viewer's pupil 2332 moves, different shutters can be switched in the filters 2307 and 2320 based on the determined pupil location. Thus, effective eyebox locating can be achieved.

In some examples, subsets of less than all of the beams of light originating from the lens array 2306 may be selected and time-sequentially activated to produce images in the plane 2330 in the same way as discussed above for FIG. 22.

The example display system 2300 illustrated in FIG. 23 comprises a set of one or more master sources 2302 positioned at substantially the same position, and a lens array 2306 comprising three lenses, however, it is understood that the lens array 2306 may comprise at least two lenses arranged in any pattern, and that the above discussion generalises to any number of spatially separated sets of sources and lens arrays, each having at least two lenses.

In some examples, the filter 2307 could be placed on either side of the lens array 1906 in order to block certain beams of light from being transmitted.

In some examples, one of the filters 2307 and 2320 can be omitted. For example, because of the spatial separation in the Fourier plane 2320, filter 2307 can be omitted and filter 2320 is then effective to only allow desired beams through to the viewer and will filter the effects of the other beams as discussed in more detail above because they occupy different positions in the Fourier plane, as discussed above. When it is required only to form a single image on the SLM at any one time, filter 2320 can be omitted and filter 2307 can be operative to allow a single beam through to the SLM 2308.

The above discussions with regards to VR displays are for illustration purposes only. It is understood that the display systems 2200, 2300 shown respectively in FIGS. 22 and 23 could be used in different display architectures. For example, the display systems 2200, 2300 are also suitable for augmented reality (AR) display systems, which can be understood from FIG. 21 by omitting the conventional display 2104 so that the holographic content is combined with light received from the viewer's environment. Other examples are of course possible.

To conclude, an example holographic optical engine 2400, also referred to as a holographic display system, for displaying colour holographic content and using the principles of FIGS. 21, 22 and 23 will now be described with reference to FIG. 24. The holographic optical engine 2400 comprises a set of master sources 2402 comprising first, second and third master light sources 2404, 2406, 2408, wherein each of the master light sources 2404, 2406, 2408 may be configured to generate at least partially coherent light at a respective wavelength. In one example, the master light sources 2402, 2406, 2408 may be configured to emit red, green and blue light respectively. The holographic optical engine 2400 is similar to the display system 2300 shown in FIG. 23 in that it comprises a first lens 2410, a lens array 2412, a condenser lens 2414 and an SLM 2424. Each lens of the lens array 2412 is arranged to generate an image of the light emitted by each of the master light sources 2404, 2406, 2408. In this example, the lens array 2412 is shown as having three lenses along a certain axis, so that it produces three images of each of the master light sources 2404, 2406, 2408 in that axis. Example light rays emitted by each of the master light sources 2404, 2406, 2408 are illustrated using respective line styles, and are shown, for illustration purposes, as passing through a middle lens of the lens array 2412 which is generating one image of each the master light sources 2404, 2406, 2408.

Each set of images generated by a respective lens of the lens array 2412 may be understood as an illumination system as discussed herein. Further rays are shown being emitted by the second master light source 2406 and passing through an upper lens of the lens array 2412 to produce a further image of the light source 2406. It is understood that in reality, rays from each of the master light sources 2404, 2406, 2408 are passing through each lens of the lens array 2012 to produce respective images of the master light sources 2404, 2406, 2408.

The condenser lens 2414 and a first further lens 2422 are arranged to produce images at the SLM 2424, each image corresponding to an image produced by the lens array 2412.

The holographic optical engine 2400 further comprises a switchable shutter 2418 and a second further lens 2420. The switchable shutter 2418 may comprise a liquid crystal (LC) shutter and CMYK printed slide. In an example, the printed slide comprises a digitally printed transparency sandwiched between two optical flats, although other forms of printing straight to glass are possible. In an example, the LC shutter may be an n-segment (n˜15-30) LC shutter.

A beam-splitter 2416 is used to separate light reflected by the SLM 2424 from light incident on the SLM 2424.

### Further Features

The above embodiments are to be understood as illustrative examples of the invention. Further embodiments of the invention are envisaged. For example, the principles described above can be combined with those relating to noise reduction through particular shapes of spatial filters described in WO2023/002175A1, incorporated herein by reference for all purposes.

When displaying holographic images using the techniques of this disclosure, quantisation resulting the encoding scheme for display on the SLM may reduce image quality and result in cross-talk between regions when displayed. While any suitable method can be used, it has been found that an amplitude encoding scheme, such as described in WO2023/180693, incorporated herein by reference for all purposes works well.

In addition, the techniques described herein decompose or partition the Fourier domain into different regions for different image fields. When determining a hologram corresponding to those regions, “flat phase” or “single phase” algorithms may work well. These algorithms assign a phase according to a flat gradient and produce one or more peaks or spikes in the Fourier domain. Each peak may be aligned with a region for display and help to avoid cross-talk between regions. “Multi-spike” algorithms may also work well, such as described in UK patent application number 2400478.0, filed on 12 Jan. 2024 and incorporated herein by reference for all purposes. In these examples, a greater multitude of spikes may be produced within larger regions. Other examples may also use random phase algorithms to determine a hologram for display.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

Examples are set out in the following clauses:
Clause 1. A display system comprising:
an illumination system configured to emit at least partially coherent light;
a spatial light modulator, SLM, illuminated by the illumination system and for applying a modulation pattern to illuminating light;
an optical system arranged to receive the light modulated by the SLM and to produce a Fourier plane of the SLM; and
a spatial filter positioned substantially in the Fourier plane of the SLM;
wherein:
the SLM is configured to form a single modulation pattern, H, simultaneously representing a first image field and a second image field, each occupying different portions of the Fourier Transform of H, F(H), and
the spatial filter is configured such that light corresponding to a first portion of F(H) corresponding to the first image field does not interfere coherently with light corresponding to a second portion of F(H) corresponding to the second image field.
Clause 2. The display system according to clause 1, wherein:
the illumination system comprises a first light source and a second light source;
the first light source and second light source are mutually incoherent;
light passing through a first region defined by the spatial filter, and corresponding to the first portion of F(H), originates from the first light source; and
light passing through a second region defined by the spatial filter, and corresponding to the second portion of F(H), originates from the second light source.
Clause 3. The display system according to clause 2, wherein:
the first light source has a first wavelength and the second light source has a second wavelength which is different from the first wavelength; and
the first image field is for display at the first wavelength and the second image field is for display at the second wavelength; and
the first region defined by the spatial filter comprises a spectral filter allowing the first wavelength to pass; and
the second region defined by the spatial filter comprises a spectral filter allowing the second wavelength to pass.
Clause 4. The display system according to clause 3, wherein an area of the second portion of F(H) is larger than an area of the first portion of F(H).
Clause 5. The display system according to clause 3 or 4, wherein:
the single modulation pattern further simultaneously represents a third image field occupying a different portion of F(H) from the first image field and the second image field and for display at a third wavelength, different from the first and second wavelengths,
the illumination system comprises a third light source having the third wavelength, and
the spatial filter defines a third region corresponding to the third portion of F(H), the third region comprising a spectral filter allowing the third wavelength to pass.
Clause 6. The display system according to clause 5, wherein the area of the second portion of F(H) is larger than an area of the third portion of F(H).
Clause 7. The display system according to clause 5 or 6, wherein the first wavelength corresponds to red light, the second wavelength corresponds to green light and the third wavelength corresponds to blue light.
Clause 8. The display system according to clause 7, wherein the area of the first portion of F(H) is larger than the area of the third portion of F(H).
Clause 9. The display system according to any of clauses 5 to 8, wherein the area of the second portion of F(H) is approximately twice the sum of the area of the first portion of F(H) and the third portion of F(H).
Clause 10. The display system according to any of clauses 5 to 8, wherein an area of the second region is larger than the area of both the first region and the third region.
Clause 11. The display system according to any of clauses 2 to 10, wherein the first light source and the second light source are arranged so that at the spatial filter the first region and the second region overlap.
Clause 12. The display system according to clause 11, wherein the first light source and the second light source are arranged so that at the spatial filter the first region is substantially contained within the second region.
Clause 13. The display system according to any of clauses 1 to 12, wherein the spatial filter defines a region having a shape with a largest dimension that is aligned with a direction of consecutive horizontal and/or vertical diffraction orders in the Fourier plane.
Clause 14. The display system according to clause 1, wherein the spatial filter comprises:
first and second shutters that can be switched between a state that allows light to pass and a state that blocks light, the first shutter corresponding to the first portion of F(H) and the second shutter corresponding to the second portion of F(H), wherein in use:
a single one of the first and second shutters is in the state that allows light to pass at any given time, and
both the first and second shutters are configured to be in the state that allows light to pass for respective periods within a duration that the SLM is forming the single modulation pattern.
Clause 15. The display system according to any of clauses 1 to 14, wherein:
the single modulation pattern, H, is a first modulation pattern generated at a first time,
the SLM is configured to form a second single modulation pattern, H′, at a second time different from the first time, the second single modulation pattern simultaneously representing a first further image field and a second further image field, each occupying different portions of the Fourier Transform of H′, F(H′),
the spatial filter is configured such that, at the first time, at least a first portion of F(H) is allowed to pass and F(H′) is blocked by the spatial filter, and
the spatial filter is further configured such that, at the second time, F(H) is blocked and at least a first portion of F(H′) corresponding to the further first image field is allowed to pass.
Clause 16. The display system according to any of clauses 1 to 14, wherein the illumination system is a first illumination system, and the display system further comprises:
a second illumination system configured to emit at least partially coherent light, which is spatially offset from the first illumination system;
and wherein:
the single modulation pattern, H, is a first modulation pattern generated at a first time,
the SLM is configured to form a second single modulation pattern, H′, at a second time different from the first time, the second single modulation pattern simultaneously representing a first further image field and a second further image field, each occupying different portions of the Fourier Transform of H′, F(H′), and
the spatial filter is configured so that:
at the first time, at least a portion of light from the first illumination system is allowed to pass and light from the second illumination system is not allowed to pass, and
at the second time, at least a portion of light from the second illumination system is allowed to pass and light from the first illumination system is not allowed to pass.
Clause 17. The display system according to clause 16, comprising:
a pupil tracking system configured to determine a location of a viewer's pupil; and
a processing system configured to:
determine which of the first and second illumination systems corresponds to the determined location of the viewer's pupil; and
control the first and second illumination systems based on the determined pupil location.
Clause 18. The display system according to clause 16 or 17, further comprising one or more master sources, wherein:
the first illumination system comprises first images of the one or more master sources, and
the second illumination system comprises second images of the one or more master sources.
Clause 19. The display system according to clause 18, further comprising a lens array, wherein:
the first images are formed by a first lens of the lens array, and
   the second images are formed by a second lens of the lens array.
Clause 20. The display system according to clause 19, comprising a further spatial filter positioned after the lens array for controlling which of the first and second illumination systems illuminates the SLM.
Clause 21. A spatial filter for positioning substantially in a Fourier plane of
a spatial light modulator in a display system, the spatial filter defining:
a first region allowing a first subset of the visible electromagnetic spectrum to pass; and
a second region allowing a second subset of the visible electromagnetic spectrum to pass;
wherein:
the first subset of the visible electromagnetic spectrum is different from the second subset of the visible electromagnetic spectrum and the first and second regions at least partially overlap.
Clause 22. The spatial filter according to clause 21, defining a third region allowing transmission of a third subset of the visible electromagnetic spectrum to pass that is different from the first and second subsets of the visible electromagnetic spectrum;
wherein:
the first subset of the visible electromagnetic spectrum includes red light, the second subset of the visible electromagnetic spectrum includes green light and the third subset of the visible electromagnetic spectrum includes blue light, and
an area of the second region is larger than areas of both the first and third regions.
Clause 23. The spatial filter according to clause 22, wherein the area of the first region is larger than the area of the third region.
Clause 24. A display system comprising the spatial filter of any of clauses 21 to 23.
Clause 25. A head-mounted display or a head-up display comprising the display system according to any of clauses 1 to 20 and 24.
Clause 26. A method comprising:
determining a first modulation pattern, H₁, corresponding to a first image field;
determining a second modulation pattern, H₂, corresponding to a second image field;
displaying H₁ and H₂ simultaneously via a single modulation pattern on an SLM;
illuminating the SLM with an at least partially coherent light source to produce a modulated output; and
filtering the modulated output using a spatial filter;
wherein the spatial filter:
is substantially positioned in a Fourier plane of the SLM,
defines a first region corresponding to the Fourier transform of H₁, F(H₁);
defines a second region corresponding to the Fourier transform of H₂, F(H₂), and
is configured such that light corresponding to F(H₁) does not interfere coherently with light corresponding to F(H₂).
Clause 27. The method according to clause 26, wherein:
the first image field corresponds to a first portion of the visible electromagnetic spectrum,
the second image field corresponds to a second portion of the visible electromagnetic spectrum, and
the first portion of the visible electromagnetic spectrum is different from the second portion of the visible electromagnetic spectrum.
Clause 28. The method according to clause 26 or clause 27, wherein:
light allowed to pass by the first region originates from a first at least partially-coherent light source and light allowed to pass by the second region originates from a second at least partially-coherent light source,
the first and second at least partially-coherent light sources are mutually incoherent, and
wherein the first and second at least partially-coherent light sources are arranged such that the first and second regions at least partially overlap in the Fourier plane.
Clause 29. The method according to any of clauses 26 to 28, wherein H₁ and H₂ are displayed at a first time and a first illumination system comprising the at least partially coherent light source illuminates the SLM at the first time, the method further comprising:
determining a third modulation pattern, H₃, corresponding to a third image field;
determining a fourth modulation pattern, H₄, corresponding to a fourth image field; and
displaying, at a second time different from the first time, H₃ and H₄ simultaneously via a further single modulation pattern on the SLM,
illuminating the SLM with a second illumination system comprising a second at least partially coherent light source, the second illumination system being spatially offset from the first illumination system;
wherein the spatial filter is further configured so that:
at the first time, light corresponding to H₁ and H₂ is allowed to pass and light corresponding to H₃ and H₄ is not allowed to pass, and
at the second time, light corresponding to H₃ and H₄ is allowed to pass and light corresponding to H₁ and H₂ is not allowed to pass.
Clause 30. The method according to clause 29, further comprising:
determining a location of a viewer's pupil; and
controlling the first and second illumination systems based on the determined pupil location.
Clause 31. A display system comprising:
a first illumination system configured to generate a first set of beams of at least partially coherent light;
a second illumination system configured to generate a second set of beams of at least partially coherent light and spatially offset from the first illumination system;
a spatial light modulator, SLM, arranged to be illuminated by the first and second sets of beams of light, wherein each of the first and second sets of beams of light are incident on the SLM at a different angle;
an output optical system arranged to receive light modulated by the SLM;
a pupil tracking system configured to determine a location of a viewer's pupil; and
a processing system configured to:
determine at least one active beam of the first and second sets of beams that corresponds to the determined location of the viewer's pupil; and
control the first and second illumination systems so that the at least one active beam is used to illuminate the SLM.
Clause 32. The display system according to clause 31, wherein the first illumination system comprises a first set of light sources and the second illumination system comprises a second set of light sources.
Clause 33. The display system according to clause 31 or 32, comprising a light emitting diode (LED) array, wherein:
the first illumination system comprises a first portion of the LED array, and
the second illumination system comprises a second portion of the LED array.
Clause 34. The display system according to clause 32, further comprising one or more master sources, wherein:
the first set of light sources is one or more first images of the one or more master sources, and
the second set of light sources is one or more second images of the one or more master sources.
Clause 35. The display system according to clause 34, further comprising a lens array, wherein:
the one or more first images are formed by a first lens of the lens array, and
the one or more second images are formed by a second lens of the lens array.
Clause 36. The display system according to clause 35, comprising:
a spatial filter positioned after the lens array for controlling which of the first and second illumination systems illuminates the SLM.

1. A display system comprising:
an illumination system configured to emit at least partially coherent light;
a spatial light modulator, SLM, illuminated by the illumination system and for applying a modulation pattern to illuminating light, the SLM configured to form a single modulation pattern, H, simultaneously representing a plurality of image fields, information relating to each image field of the plurality of image fields occupying a different portion of the Fourier Transform of H, F(H);
an optical system arranged to receive the light modulated by the SLM and to produce a Fourier plane of the SLM; and
a spatial filter positioned substantially in the Fourier plane of the SLM, the spatial filter comprising a plurality of regions, each region corresponding to a portion of F(H) representing an image field, and each region configured to pass light relating to the image field corresponding to that region;
wherein in the single modulation pattern, information relating to an image field having greatest perceptual significance to a viewer occupies a largest portion of F(H).

2. The display system of claim 1, wherein each image field is a colour channel of an image.

3. The display system of claim 1, wherein the plurality of image fields comprises at least three image fields.

4. The display system of claim 1, wherein:
the plurality of image fields comprises a red image field, a green image field and a blue image field; and
information relating to the green image field occupies the largest portion of F(H).

5. The display system of claim 1, wherein:
the plurality of image fields comprises a substantially white light field; and
the substantially white light field occupies the largest portion of F(H).

6. The display system of claim 5, wherein:
the plurality of image fields further comprises a red image field, a green image field and a blue image field.

7. The display system of claim 6, wherein information relating to the red image field, information relating to the green image field and information relating to the blue image field occupy a same size portion of F(H).

8. The display system of claim 3, wherein the plurality of image fields further comprises a yellow image field.

9. The display system of claim 3, wherein the plurality of image fields further comprises a cyan image field.

10. A display system comprising:
an illumination system configured to emit at least partially coherent light;
a spatial light modulator, SLM, illuminated by the illumination system and for applying a modulation pattern to illuminating light;
an optical system arranged to receive the light modulated by the SLM and to produce a Fourier plane of the SLM; and
a spatial filter positioned substantially in the Fourier plane of the SLM;
wherein:
the SLM is configured to form a single modulation pattern, H, simultaneously representing at least a first image field occupying a first portion of the Fourier Transform of H, F(H), and a second image field occupying a second, different portion of F(H), and
the spatial filter is configured such that light corresponding to the first portion of F(H) does not interfere coherently, or interferes partially coherently, with light corresponding to the second portion of F(H).

11. The display system according to claim 10, wherein the second portion occupies a larger area of F(H) than the first portion.

12. The display system according to claim 10, wherein the second image field is more perceptually important to a viewer than the first image field.

13. The display system according to claim 10, wherein at least one of the first image field and the second image field corresponds to a white image field.

14. The display system according to claim 10, wherein:
the single modulation pattern further simultaneously represents a third image field occupying a third portion of F(H) different from the first portion and the second portion; and
the spatial filter is further configured to filter light corresponding to at least the third portion.

15. The display system according to claim 14, wherein;
the single modulation pattern further simultaneously represents a fourth image field occupying a fourth portion of F(H) different from the first portion, the second portion and the third portion;
the spatial filter is further configured to filter light corresponding to at least the fourth portion; and
each of the first image field, the second image field, the third image field and the fourth image field corresponds to a distinct colour.

16. The display system according to claim 15, wherein one of the first image field, the second image field, the third image field and the fourth image field corresponds to a white image field.

17. The display system according to claim 14, wherein the second portion occupies a larger area of F(H) than the third portion.

18. The display system according claim 14, wherein the first portion corresponds to a red image field, the second portion corresponds to a green image field and the third portion corresponds to a blue image field.

19. The display system according to claim 18, wherein the first portion occupies a larger area of F(H) than of the third portion.

20. The display system according to claim 10, wherein the second portion corresponds to a white image field.

21. The display system according to claim 14, wherein the area of the second portion of F(H) is approximately twice the sum of the area of the first portion of F(H) and the third portion of F(H).

22. The display system according to claim 14, wherein an area of the second region is larger than the area of both the first region and the third region.

23. The display system according to claim 10, wherein at the spatial filter a first region corresponding to the first portion of F(H) and a second region corresponding to the second portion of F(H) overlap.

24. The display system according to claim 23, wherein the illumination system comprises a first light source and a second light source arranged so that at the spatial filter the first region is substantially contained within the second region.

25. The display system according to claim 10, wherein the spatial filter defines a region having a shape with a largest dimension that is aligned with a direction of consecutive horizontal and/or vertical diffraction orders in the Fourier plane.

26. The display system according to claim 10, wherein the spatial filter comprises a spectral filter.

27. A display system comprising:
an illumination system configured to emit at least partially coherent light;
a spatial light modulator, SLM, illuminated by the illumination system and for applying a modulation pattern to illuminating light;
an optical system arranged to receive the light modulated by the SLM and to produce a Fourier plane of the SLM; and
a spatial filter positioned substantially in the Fourier plane of the SLM;
wherein:
the SLM is configured to form a single modulation pattern, H, simultaneously representing at least a first image field occupying a first portion of the Fourier Transform of H, F(H), and a second image field occupying a second, different portion of F(H); and
the spatial filter comprises:
first and second shutters that can be switched between a state that allows light to pass and a state that blocks light, the first shutter corresponding to the first portion of F(H) and the second shutter corresponding to the second portion of F(H), wherein in use:
a single one of the first and second shutters is in the state that allows light to pass at any given time, and
both the first and second shutters are configured to be in the state that allows light to pass for respective periods within a duration that the SLM is forming the single modulation pattern.

28. The display system according to claim 1, wherein:
the single modulation pattern, H, is a first modulation pattern generated at a first time,
the SLM is configured to form a second single modulation pattern, H′, at a second time different from the first time, the second single modulation pattern simultaneously representing a first further image field and a second further image field, each occupying different portions of the Fourier Transform of H′, F(H′),
the spatial filter is configured such that, at the first time, at least a first portion of F(H) is allowed to pass, and
the spatial filter is further configured such that, at the second time, at least a first portion of F(H′) corresponding to the further first image field is allowed to pass.

29. The display system according to claim 28, wherein the spatial filter is further configured such that, at the first time, F(H′) is blocked by the spatial filter, and, at the second time, F(H) is blocked by the spatial filter.

30. The display system according to claim 1, wherein the illumination system is a first illumination system, and the display system further comprises:
a second illumination system configured to emit at least partially coherent light, which is spatially offset from the first illumination system;
and wherein:
the single modulation pattern, H, is a first modulation pattern generated at a first time,
the SLM is configured to form a second single modulation pattern, H′, at a second time different from the first time, the second single modulation pattern simultaneously representing a first further image field and a second further image field, each occupying different portions of the Fourier Transform of H′, F(H′), and
the spatial filter is configured so that:
at the first time, at least a portion of light from the first illumination system is allowed to pass, and
at the second time, at least a portion of light from the second illumination system is allowed to pass.

31. The display system according to claim 30, wherein the spatial filter is further configured such that, at the first time, light from the second illumination system is not allowed to pass, and, at the second time, light from the first illumination system is not allowed to pass.

32. The display system according to claim 30, comprising:
a pupil tracking system configured to determine a location of a viewer's pupil; and
a processing system configured to:
determine which of the first and second illumination systems corresponds to the determined location of the viewer's pupil; and
control the first and second illumination systems based on the determined pupil location.

33. The display system according to claim 30, further comprising one or more master sources, wherein:
the first illumination system comprises first images of the one or more master sources, and
the second illumination system comprises second images of the one or more master sources.

34. The display system according to claim 33, further comprising a lens array, wherein:
the first images are formed by a first lens of the lens array, and
the second images are formed by a second lens of the lens array.

35. The display system according to claim 34, comprising a further spatial filter positioned after the lens array for controlling which of the first and second illumination systems illuminates the SLM.

36. A head-mounted display or a head-up display comprising the display system according to claim 1.

37. A method comprising:
determining a first modulation pattern, H₁, corresponding to a first image field, wherein the Fourier transform of H₁, F(H₁) occupies a first portion of the Fourier domain;
determining a second modulation pattern, H₂, corresponding to a second image field, wherein the Fourier transform of H₂, F(H₂) occupies a second portion of the Fourier domain which is different from the first portion
displaying H₁ and H₂ simultaneously via a single modulation pattern on an SLM;
illuminating the SLM with at least partially coherent light to produce a modulated output; and
filtering the modulated output using a spatial filter substantially positioned in a Fourier plane of the SLM and configured such that light corresponding to F(H₁) does not interfere coherently, or interferes partially coherently, with light corresponding to F(H₂).

38. The method according to claim 37, wherein the second portion is larger than the first portion.

39. The method according to claim 37, wherein:
the first image field corresponds to a first subset of the visible electromagnetic spectrum,
the second image field corresponds to a second subset of the visible electromagnetic spectrum, and
the first subset of the visible electromagnetic spectrum is different from the second subset of the visible electromagnetic spectrum.

40. The method according to claim 37, wherein the spatial filter comprises a first region corresponding to the first portion of F(H) and a second region corresponding to the second portion of F(H) and the first and second region at least partially overlap.

41. The method according to claim 40, wherein,
light allowed to pass by the first region originates from a first at least partially-coherent light source and light allowed to pass by the second region originates from a second at least partially-coherent light source,
the first and second at least partially-coherent light sources are mutually incoherent, and
wherein the first and second at least partially-coherent light sources are arranged such that the first and second regions at least partially overlap in the Fourier plane.

42. The method according to claim 37, wherein H₁ and H₂ are displayed at a first time and a first illumination system comprising the at least partially coherent light source illuminates the SLM at the first time, the method further comprising:
determining a third modulation pattern, H₃, corresponding to a third image field;
determining a fourth modulation pattern, H₄, corresponding to a fourth image field; and
displaying, at a second time different from the first time, H₃ and H₄ simultaneously via a further single modulation pattern on the SLM,
illuminating the SLM with a second illumination system comprising a second at least partially coherent light source, the second illumination system being spatially offset from the first illumination system;
wherein the spatial filter is further configured so that:
at the first time, light corresponding to H₁ and H₂ is allowed to pass, and
at the second time, light corresponding to H₃ and H₄ is allowed to pass.

43. The method according to claim 42, wherein the spatial filter is further configured so that, at the first time, light corresponding to H₃ and H₄ is not allowed to pass, and, at the second time, light corresponding to H₁ and H₂ is not allowed to pass.

44. The method according to claim 42, further comprising:
determining a location of a viewer's pupil; and
controlling the first and second illumination systems based on the determined pupil location.

45. A display system comprising:
a first illumination system configured to generate a first set of beams of at least partially coherent light;
a second illumination system configured to generate a second set of beams of at least partially coherent light and spatially offset from the first illumination system;
a spatial light modulator, SLM, arranged to be illuminated by the first and second sets of beams of light, wherein each of the first and second sets of beams of light are incident on the SLM at a different angle;
an output optical system arranged to receive light modulated by the SLM;
a pupil tracking system configured to determine a location of a viewer's pupil; and
a processing system configured to:
determine at least one active beam of the first and second sets of beams that corresponds to the determined location of the viewer's pupil; and
control the first and second illumination systems so that the at least one active beam is used to illuminate the SLM.

46. The display system according to claim 44, wherein the first illumination system comprises a first set of light sources and the second illumination system comprises a second set of light sources.

47. The display system according to claim 44, comprising a light emitting diode (LED) array, wherein:
the first illumination system comprises a first portion of the LED array, and
the second illumination system comprises a second portion of the LED array.

48. The display system according to claim 45, further comprising one or more master sources, wherein:
the first set of light sources is one or more first images of the one or more master sources, and
the second set of light sources is one or more second images of the one or more master sources.

49. The display system according to claim 47, further comprising a lens array, wherein:
the one or more first images are formed by a first lens of the lens array, and
the one or more second images are formed by a second lens of the lens array.

50. The display system according to claim 48, comprising:
a spatial filter positioned after the lens array for controlling which of the first and second illumination systems illuminates the SLM.
